(19) United States
(12) Patent Application Publication
(10) Pub. No.: US 2017/0032166 A1
(43) Pub. Date: Feb. 2, 2017

(54) HANDHELD BIOMETRIC SCANNER DEVICE

(71) Applicant: CROSS MATCH TECHNOLOGIES, INC., Palm Beach Gardens, FL (US)

(72) Inventors: DANIEL H. RAGUIN, NORTH PALM BEACH, FL (US); GEORGE W. MCCLURG, JENSEN BEACH, FL (US); CURT M. CHANDLER, SATELLITE BEACH, FL (US); GREGORY L. CANNON, LAKE WORTH, FL (US); CHRISTOPHER R. FULMER, JUPITER, FL (US)

(21) Appl. No.: 15/154,978

(22) Filed: May 14, 2016

Related U.S. Application Data
(60) Provisional application No. 62/161,864, filed on May 14, 2015.

(51) Int. Cl. G06K 9/00

(52) U.S. Cl. CPC G06K 9/0004

(57) ABSTRACT

The invention provides a mobile and compact enclosure that can be carried within a pocket of clothing while providing a large dear aperture for both a fingerprint scanner and a visual display contained within the apparatus. The apparatus of this invention is not limited to facilitating one or two-finger fingerprint scanning, and can incorporate a scanner capable of scanning four fingers simultaneously.

### CROSS REFERENCE TO RELATED PATENT APPLICATION(S)

This document is a United States (utility) non-provisional patent application that claims priority and benefit under 35 U.S.C. 119 (e) to co-pending U.S. (utility) provisional patent application having Ser. No. (62/161,864) (Confirmation No. 2313) Docket Number: CMT-013P), that was filed on May 14, 2015 and that is entitled “HANDHELD BIOMETRIC SCANNER DEVICE”, and which is incorporated herein by reference in it's entirely.

### FIELD OF INVENTION

The present invention relates to a mobile, handheld, pocket storable, biometric device that is capable of scanning fingerprints. The device incorporates a mechanical design where at least a display and a fingerprint scanner are integrated into mechanical enclosures that are at opposite sides relative to a hinge mechanism. The hinge mechanism allows the display to be set at several orientations relative to the fingerprint scanner. The hinged mechanism allows the biometric device to fit within an enclosure sufficiently small so as to fit within a person's clothing pocket and provides several ease of use advantages for an operator and/or a subject (person) to interact with the fingerprint scanner and display.

### BACKGROUND OF THE INVENTION

In today's market there are numerous examples of mobile electronic devices that incorporate a biometric scanner. Most of these devices incorporate a display such as an LCD (Liquid Crystal Display) or OLED (Organic Light Emitting Diode) screen and a fingerprint scanner. These devices further include one or more processors (for example an Intel CPU—central processing unit, or a DSP—digital signal processor) to control the operation of the display and that of the fingerprint scanner as well as some electronic memory for storing software program control instructions, storing graphics to display on the screen, and storing images and templates generated by the fingerprint scanner.

Examples of such mobile biometric devices geared towards the AFIS (Automated Fingerprint Identification Systems) biometrics market include the L-1 HIIDE 5.0 and Cross Match Technologies SEEK Avenger. These devices can include additional features such as cellular and wireless antenna communication, ability to determine the position of the device through GPS (Global Position System), hot swappable rechargeable batteries, USB ports, microphone and speaker jacks, and face and iris capture cameras along with illumination LEDs (Light Emitting Diodes). Though quite functional, these devices tend to be bulky (5.3″×3.0″×7.5″ for the case of the HIIDE 5.0 and 6.2″×9.5″×1.8″ for the SEEK Avenger) and do not lend themselves to be carried in one's pant or shirt pocket.

Electronic devices incorporating biometrics that are geared towards the consumer market include laptops and cell phones. These consumer electronic devices incorporate a flat or swipe type fingerprint scanner and cover both clamshell like and fixed enclosure housing designs.

U.S. Pat. Application 2013/0181909 to Voronel, teaches a computing device in a clamshell enclosure where one side of the clamshell enclosure houses a display and the other side houses a keyboard and further teaches that biometrics such as gestures and fingerprints can be captured by a touch display. U.S. Pat. Application 2012/0096542 to Shea, also teaches a clamshell-enclosed electronic device with a display and keyboard, but where the fingerprint scanner is on the display side of the clamshell.

In U.S. Pat. No. 6,141,436, Srey et al teach different embodiments of a cellular phone that incorporates a fingerprint scanner. As taught by Srey, the cellular phone can be a clamshell enclosure design where on one side of the mechanical clamshell is a display and on the other side of the clamshell's hinge is a keyboard. For this embodiment, Srey shows a touch, single-finger, fingerprint scanner mounted to the outside of the mechanics holding the display for purposes of access control. For a non-clamshell design, Srey shows a fingerprint scanner that is integrated to one side of the cell phone's keyboard as well as another embodiment where the fingerprint scanner is mounted on the side edge of the enclosure housing the display.

In U.S. Pat. Appl. 2014/0137233 Salter et al teach that a fingerprint scanner can be integrated into one of the keys of a cell phone's keyboard, such as the space bar. In U.S. Pat. No. 7,725,511 Kadi teaches an electronic device that in one embodiment comprises a clamshell enclosure design with a display on one side of the clamshell binge and a keyboard on the other side of the clamshell hinge, where the keyboard preferentially has keys that are able to read fingerprints of individual fingertips when the keys are selected by the operator, who is a person operating the device.

The consumer electronic devices integrate(with fingerprint scanners taught in the prior art have finger capture areas that are significantly smaller than the display and mechanical footprint of the device. For example, the Apple iPhone fingerprint scanner has an approximate 8 mm (0.31″) diameter vs the display diagonal of 4.0″ for the Apple iPhone 5S and 4.7″ display diagonal for the Apple iPhone 6. Consumer laptops and cell phones use fingerprint scanners for access control (e.g., logging into the computer) and 1:1 authentication (e.g., pay-by-touch applications) but these fingerprint scanners are not meant to be used for high-accuracy, large biometric database, 1:N verification, authentication, or enrollment applications because they do not capture a large enough fingerprint area or capture the fingerprint with at least 500 ppi (points-per-inch) resolution.

In contrast AFIS-quality fingerprint scanners are integrated into non-consumer hand-held devices like the SEEK Avenger. These fingerprint scanners are certified by the FBI (Federal Bureau of Investigation) to Appendix F Image Quality Standards (IQS) of the FBI Electronic Fingerprint Transmission Specification for large-biometric data base 1:N applications However, these devices that integrate AFIS-quality fingerprint scanners are bulky and do not fit into ones clothing's pocket despite integrating at the largest a FAP 45 fingerprint scanner (http://biometrics.nist.gov/cs_links/standard/ansi-overview_2010/presentations/Mobile_ID.pdf) that specifies a 1.5″×1.6″ capture area (sufficient to capture two simultaneous flat fingers Of one rolled fingerprint).

The discussion above is merely provided for general background information and is not intended to be used as an aid in determining scope of the claimed subject matter.

### BRIEF DESCRIPTION OF THE INVENTION

The invention provides a solution that allows for a compact enclosure enabling the mobile apparatus to fit within the pockets of clothing while enabling a maximum dear aperture for both a fingerprint scanner and a visual display contained within the apparatus. The apparatus of this invention is not limited to single or two-finger fingerprint scanners, but preferably incorporates a scanner capable of scanning four fingers simultaneously. The solutions presented will also illustrate numerous method applications Of the fingerprint scanner relative not contemplated by the prior art nor possible given the smaller sizes of the clear aperture of their incorporated fingerprint scanners.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention can encompass other equally effective embodiments.

The drawings are not necessarily to scale. The emphasis of the drawings is generally being placed upon illustrating the features of certain embodiments of the invention. In the drawings, like numerals are used to indicate like parts throughout the various views. Differences between like parts may cause those parts to be indicated with different numerals. Unlike parts are indicated with different numerals. Thus, for further understanding of the invention, reference can be made to the following detailed description, read in connection with the drawings in which:

FIG. 1 is an isometric view of the basic apparatus of the present invention;

FIG. 2 is an isometric view of the detailed apparatus of the present invention;

FIG. 3 is a block diagram of the present invention;

FIG. 4 schematically depicts the present invention in Configuration 1 where display and fingerprint scanner are facing each other.

FIG. 5 illustrates how a disinfection means may be integrated into the apparatus and executed when the apparatus is in Configuration 1.

FIGS. 6A and 6B schematically depicts the present invention in Configuration 2 where display and fingerprint scanner are in roughly the same plane and next to each other.

FIGS. 7A and 7B depicts the present invention in Configuration 2 and illustrates how the apparatus may be used in different orientations relative to the subject.

FIGS. 8A and 8B depicts the present invention in Configuration 2 and illustrates how the apparatus may be used in orientations different than those shown in FIG. 7A and 7B as well in FIG. 8B how apparatus may be used to capture rolled prints.

FIG. 9A illustrates how the display field-of-view might be designed such that the operator can view the display imagery, while the subject cannot or has limited view.

FIG. 9B illustrates how a lenticular array may be used to dynamically change the viewing angle of the display.

FIG. 10 schematically depicts the present invention in Configuration 3 where display enclosure is rotated approximately 180° such that e fingerprint scanner and display are on opposite sides of the apparatus.

FIG. 11 depicts how the present invention in Configuration 3 can be used to view the fingerprints of a subject in real time through use of the display.

FIG. 12 depicts how the present invention in Configuration 3 can be used to view outlines or shaded depictions of the fingerprints of a subject in real time through use of the display.

FIG. 13A illustrates how the subject may grasp the apparatus while in Configuration 3 with both fingers and thumb and still see his fingerprints via the display of the apparatus. In FIG. 13B, the contact point of the thumb or other finger touching the display may be recorded by the touch sensing technology that is part of the display.

FIG. 14 illustrates a Configuration 4 of the apparatus where the display is folded and rotated under the fingerprint scanner enclosure, so that it is protected and faces the inside of the apparatus.

FIG. 15 illustrates a Configuration 5 of the apparatus where the fingerprint scanner is folded and rotated under the display enclosure, so that it is protected and faces the inside of the apparatus.

FIG. 16 illustrates an exemplary hinge mechanism that allows for the orientations of the display and fingerprint scanner mechanical enclosures required to achieve Configurations 4 and 5.

FIG. 17 illustrates a Configuration 6 of the apparatus where the display mechanical enclosure is rotated roughly 90 degree to the mechanical enclosure containing the fingerprint scanner.

FIG. 18 illustrates a Configuration 7 apparatus the apparatus may be placed in where the mechanical enclosure of the display is physically separated from the mechanical enclosure containing the fingerprint scanner.

FIG. 19 illustrates a method of fingerprinting all required fingers simultaneously.

FIG. 20. Illustrates a method of fingerprinting where finger(s) of subject and finger(s) of operator are simultaneously scanned.

FIGS. 21A-21C depict means by which the apparatus may be affixed to a surface.

FIG. 22 is a flow chart depicting a sample work flow for identification and verification application

FIG. 23 is a flow chart illustrating the fingerprint enrolling of an unknown subject.

FIGS. 24A-24C collectively illustrate embodiments for interaction between the display and fingerprint scanner.

### DETAILED DESCRIPTION OF THE INVENTION

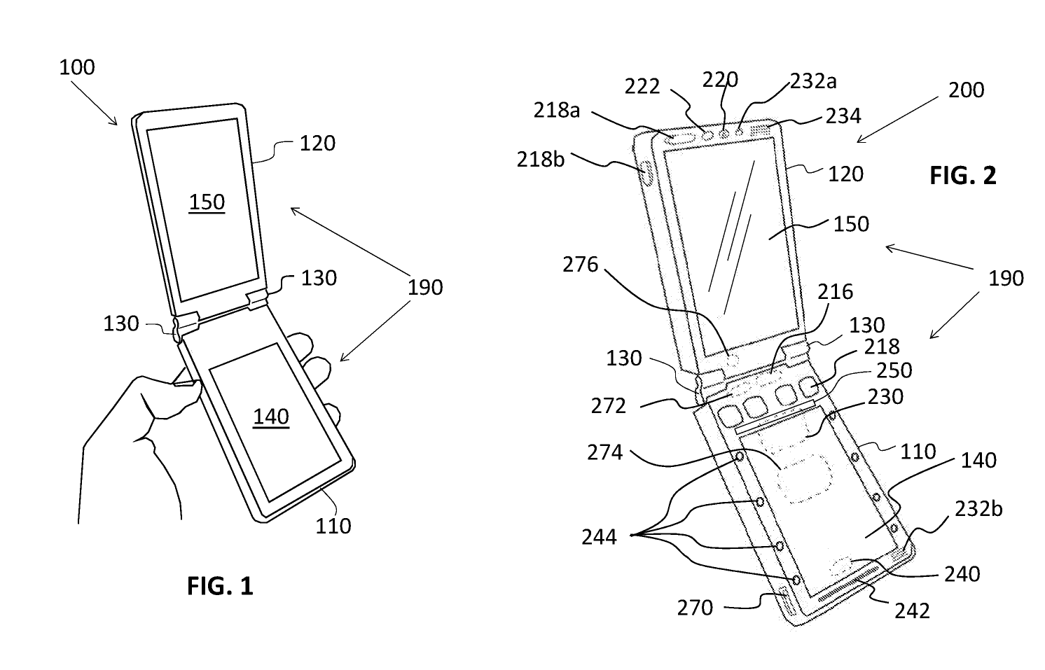

FIG. 1 is an isometric view of the basic apparatus of the present invention. Depicted in FIG. 1 is a schematic of the apparatus 100 of the current invention where the apparatus 100 comprises two mechanical enclosures 110, 120 joined by a hinge 130. The two mechanical enclosures 110, 120 joined by a hinge 130 are also collectively referred to herein as a housing 190. The first mechanical enclosure (Enclosure 1) 110 contains at least a fingerprint scanner 140 and the second mechanical enclosure (Enclosure 2) 120 contains at least an electronic user interface display 150, also referred to herein as a display 150.

The fingerprint scanner 140 may incorporate any known technology for scanning fingerprints, but preferably includes technology enabling the fingerprint scanner to be thin, compact, lightweight and low-power, all valuable properties of a component that is to be incorporated into a mobile band-held device. In some embodiments, the fingerprint scanner 140 incorporates thin-film transistor (TFT) technologies capable of scanning fingerprints based upon such properties as optical, electrical, or thermal.

By way of example, TFT technology is capable of scanning fingerprints optically and of scanning electrical (e.g., capacitance) properties of fingerprints and of scanning the thermal properties of fingerprints.

The fingerprint scanner may also include ultrasound based technologies such as those developed by Sonavation in Palm Beach Gardens, Fla. (http://sonavation.com) and Qualcomm (www.qualcomm.com) or may include a thin polymer-based capacitive scanning technology such as that developed by Idex (Oslo, Norway, www.idex.no). The fingerprint scanner may also be one incorporating waveguides and switchable Bragg gratings such as that developed by Digilens (Sunnyvale, Calif.) and which is more fully described in U.S. Patent Application 2015/0010265, U.S. Pat. No. 8,354,640, and WO 2013102759.

The fingerprint scanner 140 may be any size but is preferably having an active area of at least a (0.6″×0.8″) (Finger Acquisition Profile (FAP) 20), but is more preferably at least 45 (1.5″×1.6″) (FAP 30). The fingerprint scanner is ideally one that enables capture of fingerprint from 4 fingers, where the capture area is at least 3.0″×2.0″ and more preferably at least 3.2″×3.0″ in size. The fingerprint scanner 140 may be used for capturing the fingerprints of a subject for purposes of enrollment, verification, or identification.

The fingerprint scanner 140 through the fingerprints of the operator or subject may also be used as a means of locking or unlocking one or more of the apparatus' functions. The fingerprint scanner 140 may further provide a means of verifying the identity of the operator of the apparatus and thereby unlock attributes of the apparatus based upon the security level attributed to the fingerprints of the operator of the apparatus. The fingerprint scanner 140 may also be used to record who the operator of the apparatus was when certain operations took place.

For example, the operator's fingerprints may be recorded at a similar or same time as those of a subject's to record that a particular operator was the person taking the fingerprints of a particular subject. The operator's fingerprint may also be used to encrypt information that the operator inputs into the apparatus and therefore the fingerprint or a fingerprint assigned to the same or higher security permission level must be used for decryption and access to the encrypted data.

The foregoing discussions of the fingerprint scanner 140 may also hold true for the use and logical operation of other biometric scanners incorporated into the apparatus. The fingerprint scanner 140 may also be used as a navigation tool that guides a cursor or similar graphic on the display (see for example prior art of WO 2003049016 with priority date of Dec. 7, 2001 and U.S. Pat. No. 7,460,109 with priority date Oct. 20, 2003). Similarly the fingerprint scanner 140 may be used to input instructions onto the display screen 150 such as activation of certain buttons or graphics portrayed in the display view (e.g., analogous to the clicking of a mouse button).

The display 150 of the present invention may be any display type known to one skilled in the art. By way of example, the display may incorporate LCD (liquid crystal display), OLED (organic light emitting diode technology) or electronic ink technologies, also termed electronic paper or e-paper (such as that incorporated into e-books such as the Amazon Kindle), The display 150 may further incorporate touch reactive technologies for interaction of one or more fingers or a stylus with the display where the touch reactive technologies are known to one skilled in the art and by way of example may include resistive, capacitive, or infrared grids.

Additionally or in lieu of the touch technology, the display 150 may incorporate means (typically optical cameras) for allowing interaction with the display using air gesturing (see for example U.S. Patent Application 2011/0314425 with priority date Jun. 16, 2010). The display 150 may also have the ability to image objects that are placed on it. By placing optical sensors in back of the LCD or similar pixels, one can use the illumination of the display to illuminate a government ID or other document that is placed on the display screen 150 and capture an image. Similar technology has been shown at the SID (Society for Information Display) annual conference and trade show.

FIG. 2 is an isometric view of the detailed apparatus of the present invention. As illustrated in FIG. 2, the biometric apparatus of the present invention preferably contains additional components. The components illustrated in FIG. 2 that are drawn in solid lines are components that are at least partially visible when externally viewing the housing 190 of the apparatus 200 and those components drawn with dashed lines are components that are contained within the housing 190 of the apparatus 200. The additional components at least allow for the control and functionality of the integrated fingerprint scanner and the integrated display in a handheld environment and use-case. The apparatus preferentially contains one or more processors and memory components 230 which by way of example may be one or more of a central processing unit (CPU), a field programmable gate array (FPGA), or a digital signal processor (DSP). The processors preferentially allow for the control of at least the display and the fingerprint scanner.

Additionally it is desirable that the apparatus incorporates one Or more electronic memory storage location means such as a hard drive, solid state flash memory, or RAM (Random Access Memory) for storing information such as register settings, program control codes, images captured by the biometric scanner, biometric templates, database of biometric templates and biographic data. The apparatus 200 further preferentially includes a power supply 274 for providing power to the apparatus. The power supply 274 may be in the form of batteries where the batteries are preferably rechargeable and optionally hot swappable.

The apparatus may include means by which the internal power supply 274 may be recharged such as through the use of rechargeable batteries and use of detachable wire or through wireless induction. Where a physical connection 270 is used for power charging, the physical connection may also allow for communication to a host computer, where the communication protocol may by way of example may be one or more of USB, Firewire, Thunderbolt or other communication protocols known by one skilled in the art. The rechargeable batteries may also be charged via other forms of power generation such as solar or motion. The aforementioned processors, memory storage devices, and power supplies may be distributed amongst one or both of the first and second mechanical enclosures of the apparatus.

Additional features of the apparatus may be distributed amongst one or both of the first and second mechanical enclosures 110, 120 of the apparatus and may include a camera 220 for taking pictures of any scene, cameras designed to capture face and/or iris biometrics, or cameras designed to capture latent or other forensic information. The cameras 220 may be capable of capturing 3D information for example through the use of stereo vision or triangulation (e.g., Intel® RealSense™ Depth Camera) or through the use of structured light imaging e.g., FlashScan3D, San Antonio, Tex.).

The apparatus may also include one or more illumination modules 222 that provide or augment the ambient illumination used by the included cameras 220 to capture still images or video. The illumination modules are preferentially power efficient components such as LEDs and may include wavelength bands in one or more spectra of the ultraviolet (UV), visible, and infrared (IR). The included camera 220 may have the capability of seeing in not just the visible spectrum but also the infrared spectrum, thereby enhancing a person's night vision by relaying infrared video or stills onto the display of the apparatus. The apparatus 200 may also include systems and sensors for capturing both hard and soft biometrics i.e. gate, heart heat signatures, apparatus use signatures, and hand writing and/or signed signatures,

The apparatus 200 of the present invention may also include one or more wireless communication means 272. By way of example, the apparatus may contain the means by which it can communicate with a host computer or other electronic devices such as through use of Bluetooth, 802.11, RFID, NFC (Near Field Communications), cellular modems and networks. The apparatus may also house the capability of communicating with smart cards wirelessly or through contact.

Additionally the apparatus may be equipped with the means of determining its GPS location 216 (including through use of WiFi or network-assisted GPS 216) as well as to have a transponder (not shown), The transponder is useful for a mobile handheld apparatus of the type described herein so that if it is lost or misplaced the device can be recovered. The transponder may be linked electronically to sensors of the apparatus whereby if the sensors lose contact with the operator or sense distress, can trigger the transponder to start signaling. The sensors may include sensors to monitor heartbeat, breathing, or other biometrics of the operator, they may include an electrical sensor that is linked to a component that the officer is carrying, where the component may be one known in the art such as an RFID badge or other electronic capable of near-field communication.

The transponder may also be designed to be triggered based upon velocity or acceleration sensed via GPS signals or internal accelerometers. For example, if apparatus senses speeds of greater than 90 mph indicating a potential police pursuit or an impact of greater than 1 g indicating a crash or a fall, the transponder might be programmed to begin signaling. One skilled in the art will realize that combinations of two or more sensor signals such as sensed accelerations with certain or lack of biometric or electrical signals from the operator may also be programmed to trigger a transponder signal.

The apparatus may further include indicators 244 (lights, pictograms, etc.) to augment the control functions and feedback provided by the display. By way of example, LEDs may be used of different colors to communicate a status. For example, LEDs of different colors may be used to indicate the apparatus is in a mode ready to begin acquiring fingerprints, that a particular fingerprint is not good enough yet for acquisition, that a good fingerprint has been acquired and being analyzed, or that a fingerprint that was acquired resulted in a match. Augmenting or in lieu of the LEDs, a speaker 234 may be added wherein audible words, beeps, tones, or melodies may be played as indicator of the status of the apparatus.

Although input instructions may be received by the apparatus via the touch or air-gesture capability of the display, the instructions may also or in addition to be communicated with the apparatus via separate buttons 213, 218a-218c. These buttons 218, 218a-218c may be mechanical buttons that depress or areas of the apparatus that sense the presence of a finger where the sensing may be achieved via measurement of pressure, temperature, or electrical changes. The markings of the buttons may be static or they may contain the means for changing the markings such as with small displays (LCD, OLEDS). Input buttons 218 that change markings are beneficial in a mobile device since one may desire that the buttons change markings based upon orientation of the device.

Microphones 232, 232a-232b may be incorporated into the device in order to provide voice or speaker recognition functions and microphone arrays may be incorporated in order to determine the directionality of recorded noises, such as a processing means to determine the location where gunfire has occurred and/or other sounds of interest (i.e., explosions, cries for help, sirens, alarm systems, barking dogs, footsteps, breathing, car horns, and traffic noises). The apparatus will not need a continuous sound source for location. It will be able to process ambient sounds and lock in and identify an audible event. It will also have the ability to measure sound outside the spectrum of the human ear (i.e. dog whistles).

The apparatus may also include MRZ (Machine Readable Zone) reader 242 and/or a magnetic stripe reader 344. Preferably the readers can be utilized regardless of the configuration that the apparatus is in.

Accelerometer, electronic magnetic compass, gyro and/or other inertial (inertia) measurement unit (IMU) 240 sensors may be incorporated into the apparatus of the present invention. The sensors may provide feedback to the processing electronics of the apparatus in order to place the apparatus into a certain state based upon readings.

By way of example, the accelerometers may detect if the apparatus is dropped and the electronics of the apparatus may put the apparatus into an electronic lock mode requiring a biometric (e.g., fingerprint, face, iris, or voice) and/or a non-biometric (e.g., PIN or gesture) input to unlock the apparatus. With inputs from gyros, the orientation of the text and figures of die display 150 may change depending upon the orientation of apparatus.

These sensors may also sense the motion of the apparatus to determine and potentially react in different modes depending upon whether or not the apparatus senses it is being carried by a person that is stationary, walking, running, driving. The sensors (GPS, WiFi or Network assisted GPS) can also detect speed and record speed as well as accelerometer data. This data can be useful when conducting a forensic analysis of an accident involving the operator of the apparatus.

This biometric apparatus includes a disinfection means 250. Apparatus 200 preferentially contains a position sensor (hinge sensor) 276 that has the ability to determine if it (the housing 190) is being folded into this closed configuration where said ability may be through a mechanical and/or electrical indicator integrated into the hinge or through actuation of the locking mechanism where said locking mechanism may be one or more of a mechanism known to one skilled in the art such as a mechanical lock, a magnetic lock, and or an electronic lock.

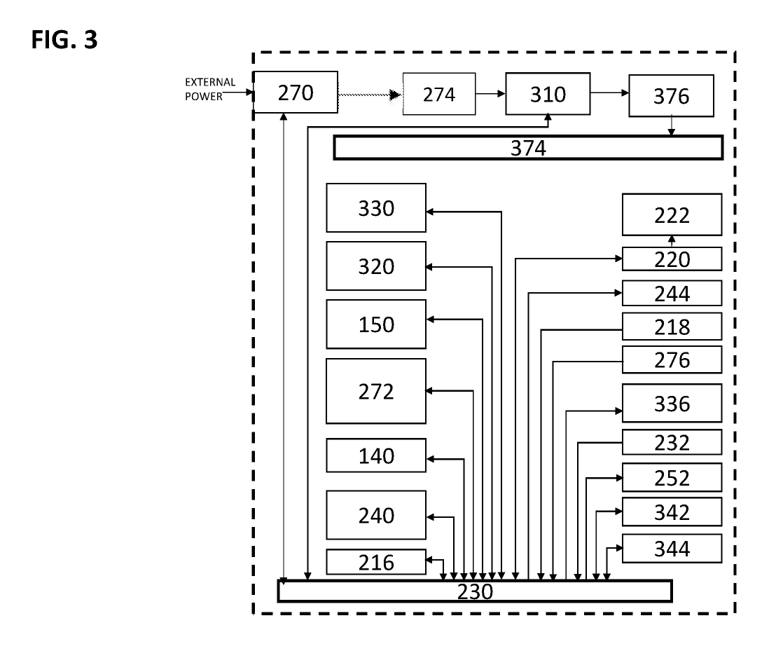

A block diagram of the apparatus of the present invention is illustrated in FIG. 3. The components and features of the apparatus are contained within the housing 190 denoted by the dashed line. As discussed earlier, the housing 190 is preferably a design comprising a first and second mechanical enclosure where the first mechanical enclosure contains a fingerprint scanner and where the second mechanical enclosure contains a display.

The two external connections illustrated in FIG. 3 are a power connection 270 and an external communication connection. As discussed earlier the apparatus preferentially has internal batteries 376 that may be recharged using external power and the apparatus may have external communication ports such as USB Or Firewire as power and/or data port, but may also communicate using wireless protocols via a wireless antenna 272. The components are all drawn connecting to a processor(s) 230 that is linked to a power supply and for the purposes of this diagram, the connection lines illustrate both a power and a communication connection.

The hinge mechanism 130 of the apparatus allows the first and second enclosures containing the fingerprint scanner 140 and display 150, respectively, to move relative to each other. As will be discussed in detail there are several advantageous configurations that the hinge mechanism 130 allows the apparatus of the present invention to conform to. Since each of these configurations may have a preferred electronic mode that the apparatus is in for each of these configurations, it is preferred that the apparatus has the means to sense the orientation of the first enclosure (Enclosure 1) 110 relative to the second enclosure (Enclosure 2) 120, in order to set the apparatus into a desired electronic configuration. The detection means may include, by way of example, magnetic position encoders that encode the angle of rotation of the first mechanical enclosure relative to the second.

Alternatively, the movement of the two enclosures relative to each other may move a mechanical tab internal to one of the enclosures and designed such that when the housing 190 is fully enclosed. the moving mechanical tab is at one position inside one of the enclosures and as the housing is opened that tab moves internally relative to the enclosure. This movement can be detected electronically (for example, by measuring capacitance or magnetic field across two contacts), thereby deciphering the relative angular position of the two mechanical enclosures. One skilled in the art may also design an electronic, magnetic, or mechanical switch that activates when the first and second mechanical enclosures are brought into contact or near contact such as for the cases of Configurations 1 and 3 through 5. A simple contact switch means for detecting Configuration 7 where the first and second mechanical enclosures are separated from each other is another possible configuration sensing means.

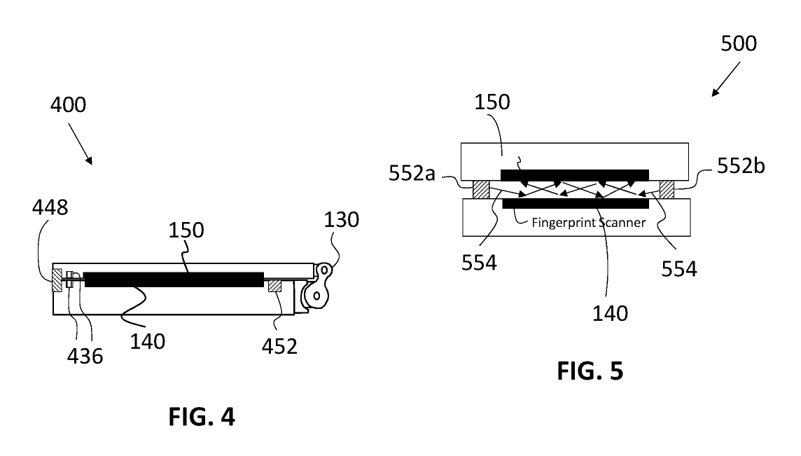

Configuration 1 of the apparatus depicted in FIG. 4 corresponds to the case where the hinge 130 is considered to be in a folded and closed position. The housing 190 is said to be in a folded state because the housing is positioned to be in its most compact size. The housing 190 is said to be closed because the fingerprint scanner 140 and display are facing each other and enclosed and protected from being exposed to physical contact with objects that are located outside of the housing 190. Hence, as shown in FIG. 4, the housing 190 is in a folded and closed state and is said to be “folded closed”. In this configuration, a cavity is formed between the display 150 and the fingerprint scanner 140.

Alternatively, the housing 190 can instead be placed into a folded open position but in this folded open position, the fingerprint scanner 140 and display 150 are exposed to physical contact with objects that are located outside of the housing 190, as shown in FIG. 10 and FIG. 20. In this position, the housing 190 is also referred to as being in a folded and open state, and is said to be “folded open”. In this configuration, no cavity is formed between the display 150 and the fingerprint scanner 140. Regardless of whether the housing 190, is folded open or is folded closed, it is configured to be carried within in a pocket of clothing, whether or not it is extending outside of the pocket, or carried by a pocket of clothing or belt for example, via a clip or other pocket/belt attachment mechanism, for example.

The apparatus 400 preferentially contains a position sensor (hinge sensor) 436 that has the ability to determine if it (the housing) 190 is being folded into this closed configuration where said ability may be through a mechanical and/or electrical indicator integrated into the hinge 130 or through actuation of the locking mechanism 448 where said locking mechanism 448 may be one or more of a mechanism known to one skilled in the art such as a mechanical lock, a magnetic lock, and or an electronic lock.

When apparatus recognizes that it is in Configuration 1 the apparatus 400 may initiate a shut-down (power-off, sleep, or a hibernation mode of the electronics, but may also, in the case of an optical fingerprint scanner, enter into a performance checking or calibration mode. By way of example, when the system enters said checking or calibration mode, it may instruct the display to project one or more patterns that the fingerprint scanner is capable of reading or receiving.

In the case of an optical fingerprint scanner 140 that measures optical properties, several different settings of uniform color and intensity may be projected by the display 150 towards the fingerprint scanner 140 and which the fingerprint scanner 140 is capable of reading. Optionally, media such as plastic, paper or cardboard, for example, having a pattern that is printed upon it, can be employed as a physical target (source) of an image and as an alternative means for projecting an optical image onto the optical fingerprint scanner 140. The printed image can be slid in between the fingerprint scanner 140 and the display 150 while the housing 190 is in a closed or nearly closed position Also, the optical fingerprint scanner 140 can be employed to optically scan an image of a document, such as some form of printed identification for a subject, into an image that is stored into memory 330 of the apparatus.

In a circumstance of employing a fingerprint scanner that measures electrical properties, the display 150 may project an electrical image such as through the use of an array of electrodes (preferably optically transparent electrodes such as those fabricated with ITO indium tin oxide) that either are specifically deposited onto the display or are integrated or part of a touch screen capability 320 the display has.

In order to couple the information projected from the display 150 to the fingerprint scanner 140 a material or materials may be placed in between the display and the fingerprint scanner, such as, but not limited to, water, isopropyl alcohol, silicone, an optical diffuser, an anisotropic electrical material, etc. For example, in the case of an optical scanner that works on the principle of TIR (Total Internal Reflection), in order to couple light from the display 150 into the fingerprint scanner 140, an air gap will normally prevent such coupling. The fingerprint scanner 140 may have enough internal scattering sites required to couple sufficient light at a TIR angle that the performance of the fingerprint scanner can be monitored.

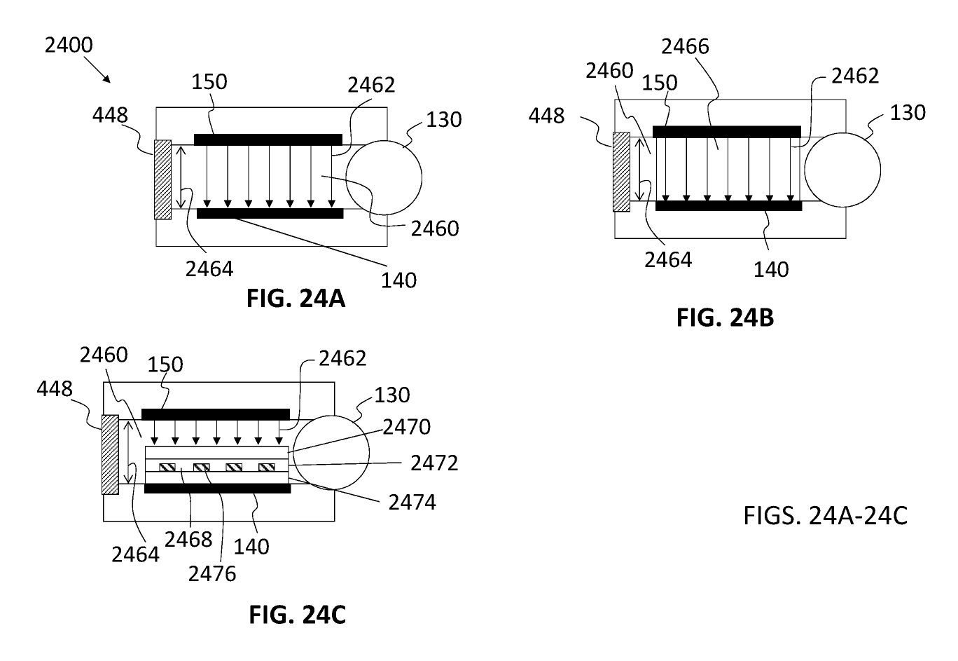

Alternatively, an optically coupled diffuser (for example a holographic, surface-relief, or volume diffuser (See. FIGS. 24A-24C) may be placed onto the platen of the fingerprint scanner 140 where said coupling is achieved via used of a liquid or cured silicone. Silicone is advantageous as it is self-wetting, has been shown to work well with fingerprint scanners (see for example U.S. Pat. No. 7,319,565), and can be easily removed. A liquid that is readily available for wetting of the diffuser is water, but one may also use common solvents such as isopropyl alcohol as they evaporate quickly and are easy to clean off of the apparatus.

In the case of an apparatus that used a liquid in conjunction with a diffuser for checking fingerprint performance, it is advantageous that the housing is substantially water proof particularly in the areas of the display and fingerprint scanner, but this is true regardless of the performance checking art taught herein since a mobile handheld apparatus is potentially exposed to a raining or at least a misting environment and hence beneficial that said apparatus is constructed to be as water-tight as possible. For both the case of an optical or electrical sensing fingerprint scanner the air gap between said fingerprint scanner and the display should be minimized.

If there is an issue with an electrical-sensing fingerprint scanner being too far from the display an anisotropic electrical material (one that conducts primarily in one direction) can be used in order to electrically “wet” the display projecting the electrical information to the fingerprint scanner that is detecting said information. Anisotropic electrical materials have been produced by Hitachi Chemicals and Sony Chemicals.

By analyzing the fingerprint scanner's collected image(s) in response to the display's one or more projected images, fingerprint scanner information such as background image, defective pixels, PRNU (Photo Response Non-Uniformity), SNR (Signal-to-Noise Ratio) and FPN (Fixed Pattern Noise) can be determined and corrected. The electronics of the apparatus can record the time and date of the fingerprint calibration and determine the performance of the fingerprint scanner before and after calibration as well as inform an operator (via the display 150, indicators 244a-244d, audibly, or wireless communication 272) the result of the calibration procedure, in particular if the fingerprint scanner 140 is no longer in compliance to manufacturing performance specifications,

By way of example, the grayscale linearity of the fingerprint scanner 140 may be checked by successively projecting different levels of uniform display imagery and by performing linear regression of the gray scale response of the fingerprint scanner to the calibrated brightness of the various spatially flat imagery projected by the display, the grayscale linearity of the scanner can be determined. Similarly if the fingerprint scanner 140 is determined to be calibrated, it can be the display uniformity and pixel defects that is determined through this process.

The display 150 may also be set to project different series of patterns in order to test the spatial resolution of the scanner. Methods of calculating and correcting for imaging performance can be found in Appendix F Image Quality Standards (IQS) of the FBI Electronic Fingerprint Transmission Specification or the Image Processing Handbook, Sixth Edition, by John C. Russ. After performing a calibration procedure, the system may enter a shut-down (power-oil), hibernation, or sleep mode.

An additional feature of the invention when in the dosed Configuration 1 that may be present is a means of disinfection 250. Although the use of UV light for disinfection of a platen of the fingerprint scanner 140 is in the prior art (see for example CN2014138307 with priority date Jul. 6, 2009), the novelty of the housing 190 design when closed allows for both the display 150 (which preferentially has multi-touch-input capability) and the fingerprint scanner 140 to be simultaneously disinfected.

As illustrated in FIG. 5, when in Configuration 1, the apparatus may activate one or more disinfection means 552, 552a-552b, where the disinfection means may include UV light sources that emit preferably in the germicidal spectral regions of UVB and UVC, see Ultraviolet Germicidal Irradiation Handbook: UVGI for Air and Surface Disinfection by Wladyslaw Kowalski (Springer, Berlin, 2009). The UV light sources are emitted within the cavity formed between the electronic display and the fingerprint scanner when the housing is in a closed state. The germicide light sources include LEDs (such as from Sensor Electronic Technology, Inc., Columbia, S.C.) as well as low-pressure mercury arc lamps.

In FIG. 5 the aspect ratio of the gap between the display and the fingerprint scanner 140 is exaggerated slightly in order to illustrate how UV light rays 554 can travel from an optical disinfection means 552, 552a-552b and reflect back and forth between the fingerprint scanner 140 and the display, thereby disinfecting both simultaneously. In order to prevent UV light 554 from escaping outside of the apparatus housing when the housing is in the closed position of Configuration 1, a relatively light-tight seal is provided by the closure of the first enclosure (Enclosure 1) 110 on top of the second enclosure (Enclosure 2) 120. The approximately (substantially) light-tight seal may be created by numerous techniques known by one skilled in the art including the use of gaskets and interlocking mechanics.

The fingerprint scanner and display either individually or both may have antimicrobial agents embedded into the material of the top layer of the respective components where the antimicrobial agents may be supplied by Seal Shield (Orlando, Fla.) to help with disinfection. The aforementioned UV disinfection process described earlier is beneficial even when antimicrobial agents are part of the componentry since the kill times of the UV disinfection is measured in seconds vs minutes and hours for typical antimicrobial agents.

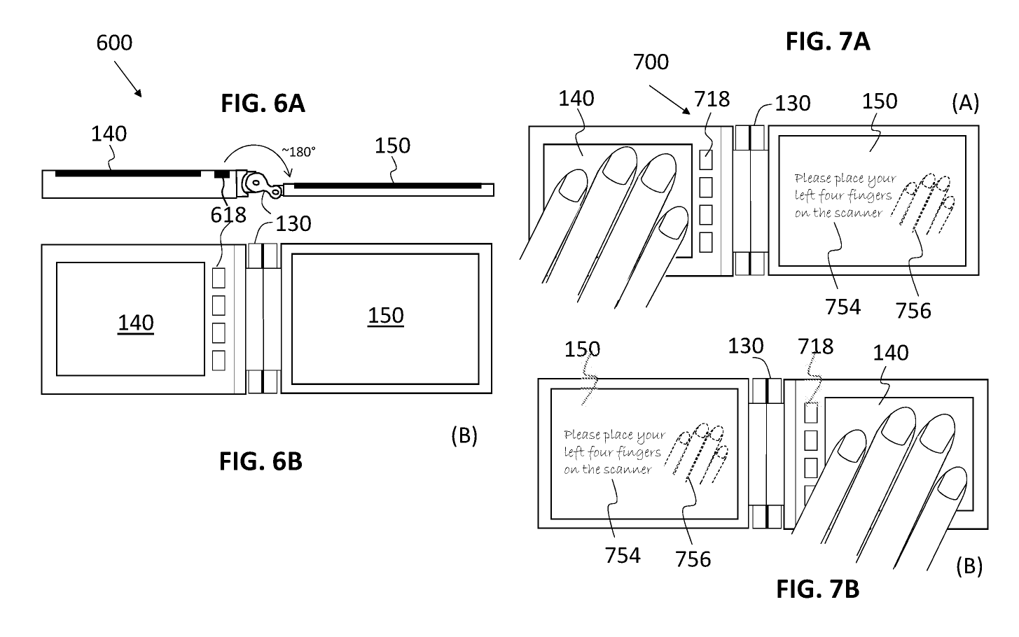

Referring to FIGS. 6A-6B, the hinge mechanism 130 allows the apparatus to be in Configuration 2 where the display enclosure is rotated approximately 180° relative to the fingerprint scanner enclosure. In this configuration 2, the housing 190 is also referred to being in an open state. However, Configuration 2 is not the only example of the housing being in an open state. As illustrated in the side view of FIG. 6a and the top-down view of FIG. 6b, while in Configuration 2, the fingerprint scanner 140 and display 150 faces are in the same plane and side by side to allow a person to place fingers on the fingerprint scanner and for the same or another person to view fingerprints captured on the display.

As depicted in FIG. 7 the apparatus preferentially works regardless of whether the apparatus is presented to the subject with the display to the left or to the right of the subject. Preferentially the apparatus has the means of flipping the orientation of text 754 and/or graphics 756 on the display 150 in order to be readable by the subject in either orientation. The means may include actuation of a button 718 incorporated into the apparatus to toggle the display orientation. The means may also include a touch or air finger(s) gesture such as touching two fingers onto the display 150 and twirling one finger around the other (for example touching ones pointer and middle finger on the display and then twirling ones middle finger about ones pointer finger) or alternatively to swipe once or twice in the direction that text is to be read to signal to the apparatus 700 that the display orientation should rotate 180 degrees.

The means may also include first orienting the apparatus with the display 150 either to the right or left of the subject as desired but then briefly tilting the apparatus so that it is substantially vertical relative to gravity. Through the incorporation of gyros or similar sensors contained within the apparatus 700, the apparatus can determine the orientation of the display 150 relative to gravity and project the required text 754 and graphics 756 in the correct orientation.

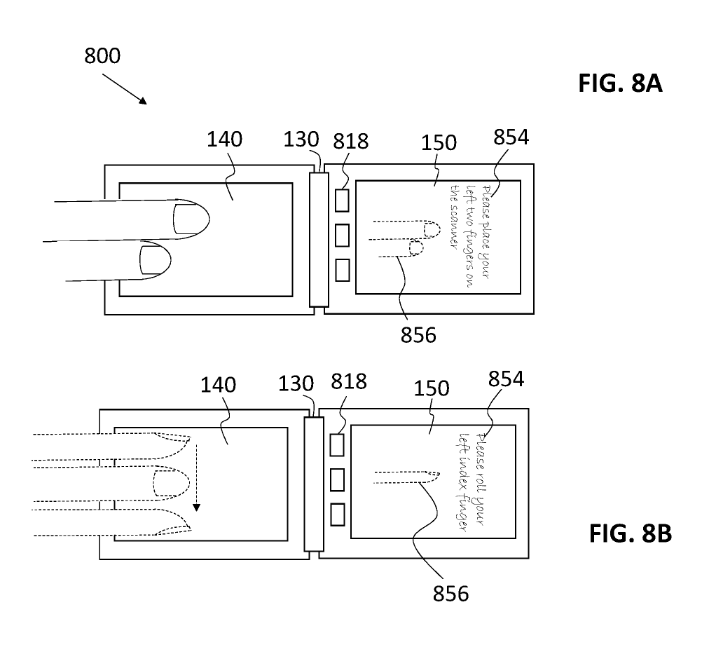

Referring to FIGS. 8A-8B, Configuration 2 may also allow for capture of fingerprints coming in from other sides of the fingerprint scanner as illustrated in FIG. 8. The subject may be asked to present his or her fingerprints as (FIG. 8A) flats or as (FIG. 8B) rolls as requested by the operator or as requested by graphic and or text of the display 150. Note that the graphic and text presented by the display to cue the subject can be static or it may change.

By way of example, when illustrating the graphic for rolling of a finger, the display 150 may show a short video (preferably in cartoon or graphic style rather than actual video of a finger), for example 5-10 frames of a finger repeatedly roiling to cue the subject to perform the same finger movement. Although FIG. 8B illustrates the rolling of a finger with the subject oriented at the left edge of the scanner 140, the subject may come in from the bottom or top edge of the scanner as long as the size of the scanner in these directions are sufficient for acquiring a rolled print.

Since the apparatus 800 may be used at a variety of different orientations relative to the subject, it is preferred that the software analyzing the images of the captured fingerprints can determine the orientation of the fingerprints. The orientation determination means may include analyzing the direction of the fingerprint blobs (areas of high spatial frequency in the image), or through analysis of direction of ridges, identifying locations of fingerprint cores, deltas, loops, etc., see for example the teachings of Zyzdryn and Raguin in U.S. Patent Application 2011/0157346 and Zyzdryn in U.S. Pat. No. 7,277,562.

In any configuration of the apparatus of the present invention, when fingerprint images are being collected, it is also preferable that the system incorporates an autocapture feature where the subject's fingerprints are automatically captured when their quality are deemed good enough without the operator or subject needing to press a button or make sonic other input to move the software to the next step in the procedure. Autocapture is described in more detail by Zyzdryn in U.S. Pat. No. 7,277,562.

As described in the operation of the apparatus, the display may be oriented at different angles relative to the subject. In some applications of the apparatus it may be desirable that the subject or operator of the apparatus can view the display at any angle. For other applications certain or all of these orientations it may not be desired for the subject to be able to view the display 150. Therefore in certain embodiments of the display, the viewing angle of the display may be restricted such as through the use of a privacy screen as manufactured by 3M (http://solutions.3m.com/wps/portal/3M/en_US/3MScreens_NA/Protectors/Privacy/).

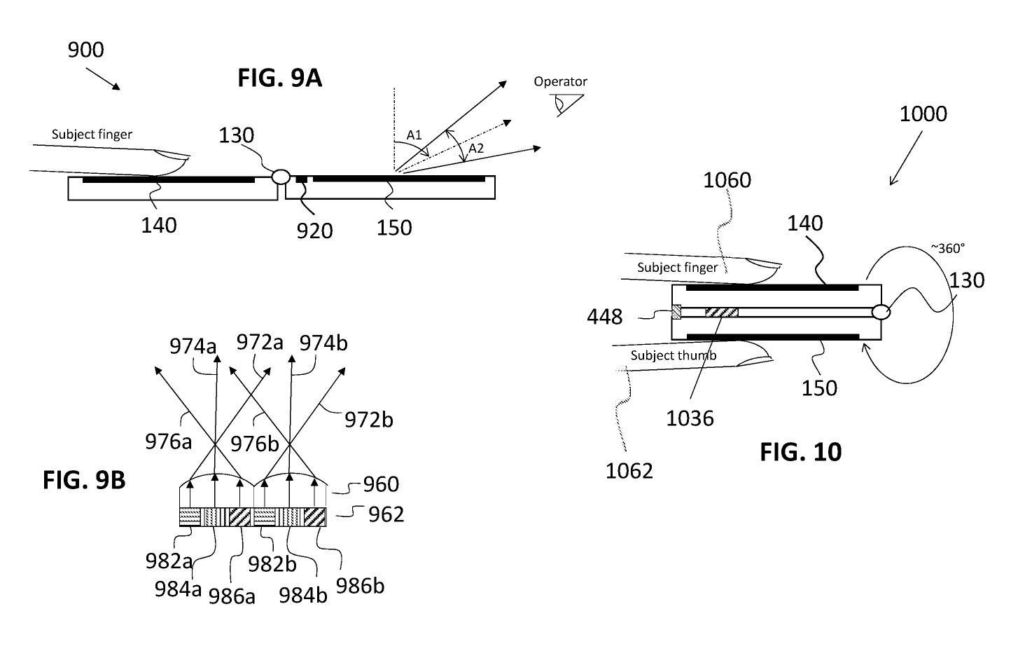

Referring to FIGS. 9A-9B, 3M or other privacy screens generally assume that the operator viewing the display 150 is looking approximately normal to the display, but the same technology can be used to restrict the viewing angle about a center angle that is tilted from the display's surface normal. As illustrated in FIG. 9B in one embodiment of the present invention, the privacy screen integrated into the display can result in a viewing FOV that is centered at an angle A1 from the normal of the display 150 with an angular spread of an angle A2 such that light from the display can only be viewed by the operator of the apparatus and not by the subject being fingerprinted.

The FOV may be static and fixed or it may be actively changed depending upon how the apparatus is oriented or changed based upon operator commands entered via a touch display, air-gesture, button, or voice. For changing the angle the display is projecting at this can be performed via a lenticular array 960 (either 1D or 2D) that is placed over the display pixels as illustrated in FIG. 9B. The suggested technology is similar to what is used in lenticular printing where a sign, sports figure, or other imagery is printed in interlaced pixel wide strips and placed in back of a ID lenticular array (e.g., a cylindrical micro-lens array) in order to have the imagery change depending upon viewing angle of the observer.

As illustrated in FIG. 9B, every 3-pixel wide row of the display is placed underneath a separate microlens of the lenticular array 960. The Pixel A 982a-982b of each 3-pixel grouping projects light in the direction of Ray A 972 and likewise for pixels B 984a-984b and C 986a-986b. By way of example, the display of the apparatus of the present invention can use only Pixels B 984a-984b if the desired viewing direction is Ray B 974a-974b or can use only Pixels C 976a-976b if the desired viewing direction is along the direction of Ray C 976a-976b. Although groupings of 3 pixels is illustrated in FIG. 9b, one skilled in the art Will realize that groupings of fewer or more pixels are possible and that groups of 2D arrays, for example a 3×3 array of display pixels in conjunction with 2D microlens arrays may be implemented in order to control the direction of light in more than one surface normal plane.

In FIG. 10 Configuration 3 of the apparatus is depicted where the display is rotated via the hinge mechanism to an angle of approximately 360 degrees relative to the fingerprint scanner such that the display 150 is underneath the fingerprint scanner 140 and both are facing approximately opposite directions. In this configuration, like in other configurations, an image representing a finger print scan is displayed via said electronic display 150. In this configuration, the scanner 140 can be presented to a subject such as to allow the subject to place one or more fingers onto the fingerprint scanner. This may be done while the apparatus is resting on a surface for support.

However, if there is no support underneath the apparatus, it is preferable that while the subject is presenting his finger or fingers 1060 to the fingerprint scanner of the apparatus that his thumb 1062 of the same hand is placed on the display side of the apparatus (as depicted in FIG. 10) such that he squeezes the apparatus thereby not providing a significant force up or down that the operator bolding the other portion of the apparatus must counteract.

As an added feature of the present invention, a pressure sensor 1036 can be optionally added to the apparatus so that in any configuration of the present invention, user feedback can be given based upon the pressure that the sensor reads since too low of a finger pressure can lead to generally faint fingerprints and too high of a pressure can lead to significant ridge flattening, both undesirable fingerprint image properties. The pressure sensor 1036 can be situated in a variety of locations of the apparatus including in either first or second mechanical enclosure as well as in the hinge mechanism itself

Referring to FIG. 10, note that in Configuration 3, the apparatus 1000 may be presented to the subject as illustrated in FIG. 10 with the fingerprint scanner oriented towards the top, but it may also be oriented towards the bottom of the apparatus. Similarly the apparatus 1000 may be presented to the subject rotated 90 degrees relative to the illustration of FIG. 10 such that when the subject's left fingers are to be scanned, the fingerprint scanner is on the left side of the apparatus and when the subject's right fingers are to be scanned, the fingerprint scanner is on the right side of the apparatus relative to the subject. Feedback that the required fingerprint images were successfully or unsuccessfully acquired may be given by the apparatus 1000 through visual cues on the display, activation of colors and timed illumination intervals of indicator lights, audio cues, or by haptic feedback via such mechanisms as vibrational or electrical impulses that can be registered by the operator of the apparatus 1000.

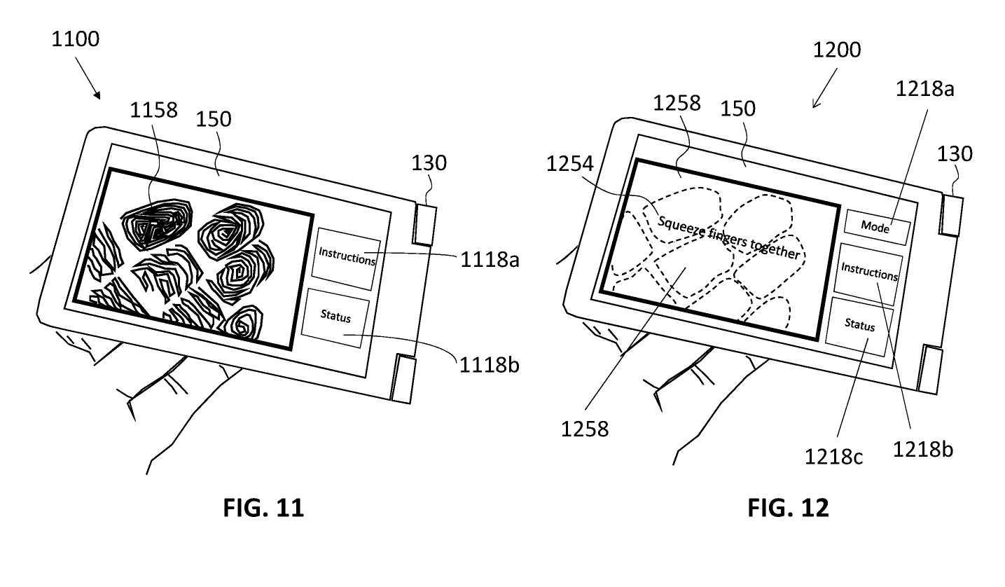

As illustrated in FIG. 11, the apparatus 1100 while in Configuration 3, may be placed on the subject's fingers and the image being collected may be actively relayed to the display 150 of the apparatus 1100. In this manner, the subject and operator can view in real time the finger placement on the scanner and the fingerprint quality being collected.

As depicted in FIG. 11, the fingerprint scanner clear aperture is smaller than that of the display 150. thereby leaving room for areas of operator and/or subject feedback on the display 150. The feedback may be in one or both of text and graphical forms and by example may have an area of the display indicating a process instructions (e.g., place left four fingers on scanner) as well as an area that indicates the mode or status of the apparatus (e.g., acquiring fingerprints, or performing match).

As shown, this apparatus 1100 provides portions of the display 150 that can be configured to be not touch sensitive and can be employed for display of particular types of information, or such portions can be configured to be touch sensitive for employment as touch screen buttons 1118a-1118b for obtaining status 1118a, and for communicating instructions 1118b, to the apparatus. A fingerprint scanner image 1158 is also displayed.

Alternatively, as in FIG. 12, an outline of the fingerprint features may be displayed on the screen display 150. When in fingerprint outline display mode, any overlay graphics or text 1254 placed in the area of the display that is projecting the fingerprint scanner image 1258 will be easier to discern by the subject and/or operator. For any overlay graphics and text 1254, it is desirable that the graphics and text is presented in a different color than the color of the fingerprint(s) or fingerprint(s) outline that the display is relaying. As shown, this apparatus 1200 is controlled by touch screen buttons 1218a-1218c for operator input 1218a and for feedback to the operator or subject, 1218b-1218c.

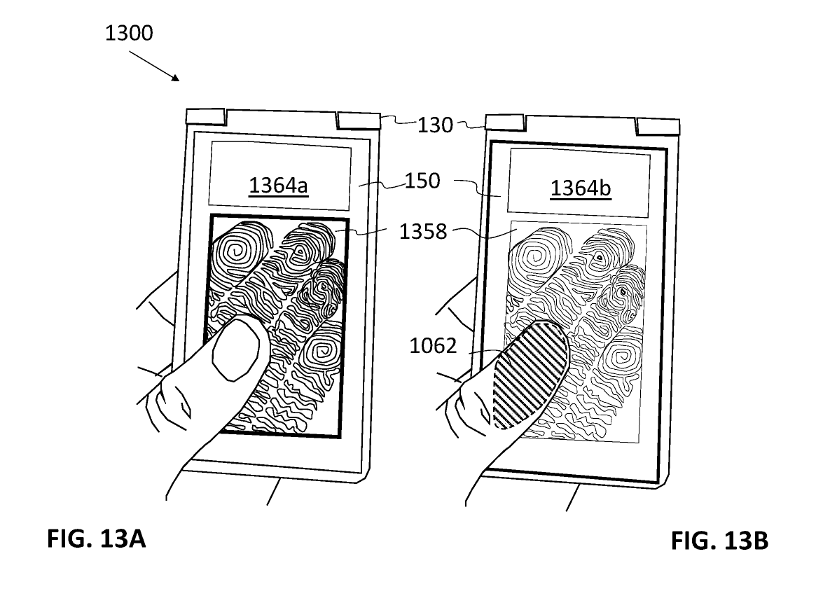

Referring to FIGS. 13A-13B, these figures illustrate a person's hand holding the apparatus 1300 while it is Configuration 3 such that the fingers are touching the fingerprint scanner on the back of the device and his thumb 1062 is touching the display portion 150 of the device. As described earlier, the fingerprint image 1358 being collected by the fingerprint scanner 140 can be relayed to the subject or operator via the display screen 150 and feedback regarding instructions for placing ones fingers Or status regarding a given processing step can be relayed on the same display screen. Even if the fingerprint scanner 140 is close to the same size as the display 150 or larger, the feedback area 1364a-1364b of the display screen 150 shown in FIG. 13 can still be programmed to be available by not relaying the fingerprint image collected by the fingerprint scanner with a 1:1 scale.

For example. a fingerprint scanner 140 that is the same size as that of the display 150, may be relayed by the display at ⅔ scale, allowing the upper 1/3 of the display to be used as area to relay instructions and feedback information. Since the display 140 is preferentially a touch display, the contact area of the thumb 1062 can also be sensed and the sensed area is denoted by the dashed outline whose interior is shaded with 45 degree stripes. This information can be useful for confirming which hand was fingerprinted due to the geometry of the thumb 1062 placement relative to the fingers. Note that in the case of a display that has the capability of sensing this thumb-touched area to the resolution required to image fingerprints, the fingerprint of the thumb 1062 may be captured simultaneously or near simultaneously to the capture of the one or more fingers placed on the fingerprint scanner 140 on the back of the apparatus while in Configuration 3.

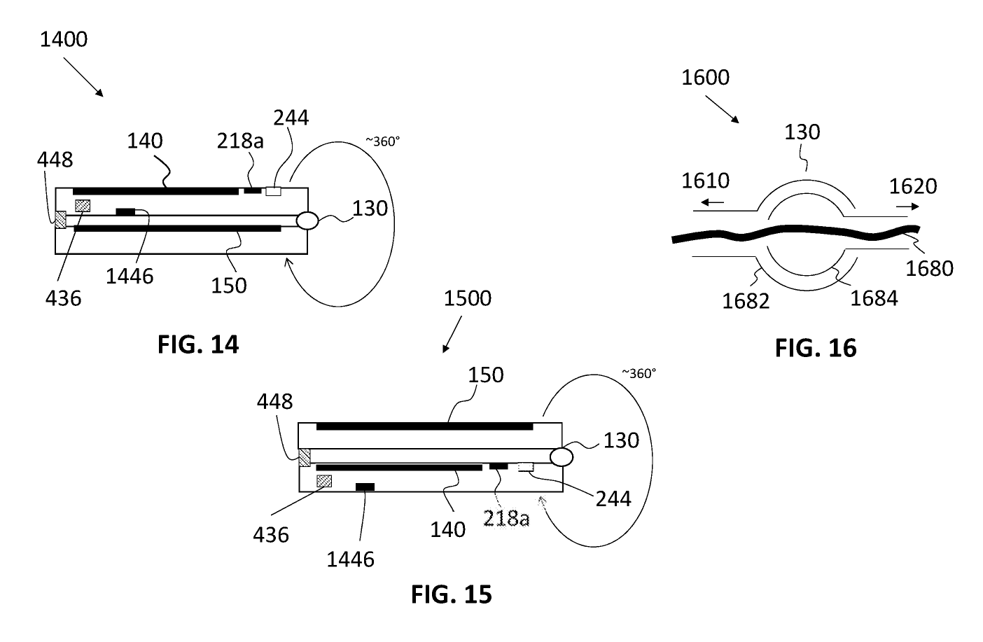

Configuration 4 of the apparatus is presented in FIG. 14 where the display mechanical enclosure in addition to being rotated 360 is rotated in the orthogonal plane by 180 degrees such that the display is underneath the fingerprint scanner as in Configuration 3, but now facing the same direction as the display such that the fingerprint scanner is mechanically protected. The operator or subject can receive feedback and instructions from the apparatus in Configuration 4 through audio cues from a speaker as well as from visual indicators. Note that the indicator lights 244 discussed throughout this patent disclosure may be simple lights of different colors, but may also be pictograms as described in U.S. Patent Application 2006/0060802. The operator or subject can give commands back to the apparatus 1400 to put the system into different modes of operations using the buttons 218a-218b, voice commands input via the apparatus' microphones 232, as well as via the fingerprint scanner 140.

By way of example, the fingerprint scanner can detect finger or stylus motion on its platen and the system may be programmed to recognize certain patterns of motions, such as letters. For example, tracing ones finger or stylus on the fingerprint platen in the form of a “V” may set the system into “Verification” mode or tracing an “E” on the fingerprint platen, may set the system into an “Enrollment” mode.

As illustrated in FIG. 14, a locking mechanism 448 is present to keep the apparatus in Configuration 4 and as discussed earlier a configuration sensor 1446 is integrated into the apparatus 1400 such that the apparatus may determine what configuration it is in and put its electronics into a preferred state given the configuration sensed. For example, if the apparatus 1400 senses that it is in Configuration 4, the display 150 can be shut down. The configuration sensor 1446 (sensing means) may be integrated into the locking mechanism 448 or may be a separate component.

FIG. 15 illustrates a Configuration 5 where similar to Configuration 4, the fingerprint scanner enclosure is rotated 360 degrees relative to the enclosure of the display 150, but now the fingerprint scanner 140 is rotated in an orthogonal plane by 180 degrees, thereby allowing the enclosure of the display 150 to be facing outwards (upwards) and on top of (above) the fingerprint scanner enclosure, but now the fingerprint scanner 140 is facing towards (upwards) the inside of the apparatus and away from the outside environment, thereby allowing the scanner 140 to be mechanically protected.

In Configuration 5 the operator has access to the display, preferably with touch input capabilities, and can interact with it, performing a variety of functions that don't require use of the fingerprint scanner. Just as in Configuration 14, the operator or subject may interact with the apparatus while in Configuration 15 using audio cues and inputs as well as buttons that might still be accessible in this configuration.

As illustrated in FIG. 15, a locking mechanism 448 is optionally present to keep the apparatus in Configuration 5 and as discussed earlier a configuration sensing means 1446 may be integrated into the apparatus 1500 such that the apparatus 1500 may determine what configuration it is in and put its electronics into a preferred state given the configuration sensed. For example, if the apparatus senses that it is in Configuration 5, the fingerprint scanner 140 can be shut down. The configuration sensing means 1446 may be integrated into the locking mechanism 448 or may be a separate component.

In FIG. 16 illustrates one possible hinge mechanism 130 that allows for rotation in two orthogonal planes. Though one skilled in the art may arrive at different designs, the ball-in-socket hinge mechanism presented allows for the movement of the apparatus' first mechanical enclosure 1610 relative to its second mechanical enclosure 1620 as described in all of the configurations presented in this disclosure. The ball 1684 disposed within a socket 1682 binge also allows for a physical communication and/or power cable 1680 to link the two mechanical enclosures 1610, 1620 if required.

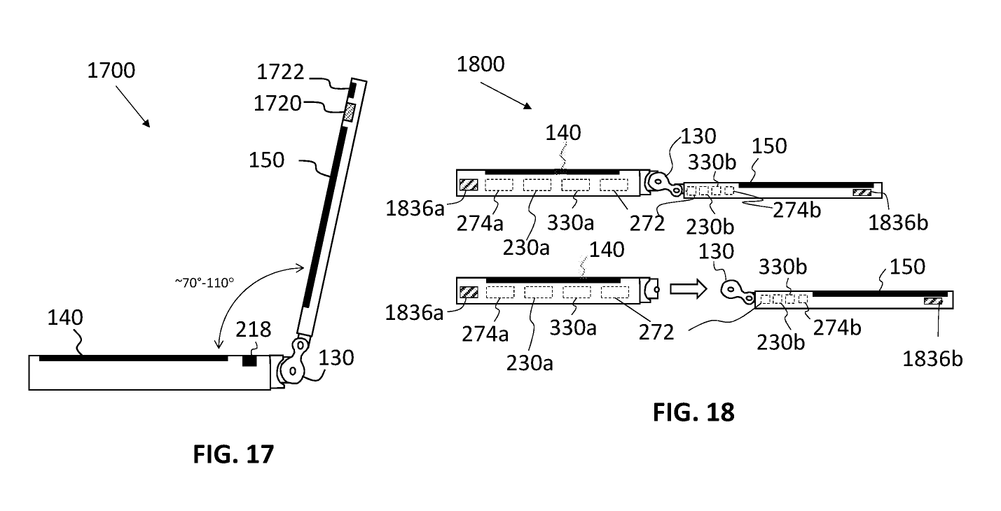

Referring to FIG. 17, the hinge mechanism 130 of the present invention may also enable the enclosure of the fingerprint scanner 140 and the enclosure of the display 150 to be approximately 90 degrees relative to each other as depicted in FIG. 17. Similar to the angle of a laptop display relative to a keyboard, depending upon how the subject operator and ambient illumination is oriented relative to the apparatus, the angle the display portion of the apparatus is rotated relative to the fingerprint scanner may be more or less than 90 degrees.

In this configuration, referred to as Configuration 6, the person using the fingerprint scanner 140 can also see the display screen 150. The person may use the fingerprint scanner 140 for purposes of access control, identification, verification or enrollment or may be using the fingerprint scanner 140 as a navigation and selection device for controlling and interacting with information viewed on the display 150. A camera 1720, capable of single images or streaming including illumination 1722 if needed, may also be incorporated into the apparatus for purposes of collecting additional biometrics such as face and iris or may be used to provide a video recording of the user's session with the apparatus,

In FIG. 18, Configuration 7 is illustrated where the hinge mechanism 130 allows the first mechanical enclosure to physically separate from the second mechanical enclosure. To allow for the display 150 and fingerprint scanner 140 of each respective enclosure to continue to operate, it is preferred that the first and second mechanical enclosure contain a power supply 274a-274b, processor 230a-230b, memory 330a-330b, and a wireless communication means 272. The wireless communication means 272 preferably allows the two enclosures to communicate with each other. Configuration 7 may be advantageous when fingerprinting a subject(s) that may be a potential threat.

First mechanical enclosure (Enclosure 1) containing the fingerprint scanner 140 may be separated from the second enclosure (Enclosure 2) and mounted on a surface where the subject(s) will be for fingerprinting. The operator holding or haying access to the second enclosure that contains the display 150 can then be at a safe distance from the subject(s). The operator may be able to communicate verbally with the subject(s) but may also use the speaker and microphone communication system 1836a-1836b that may be integrated into both first and second enclosures, respectively.

Alternatively, instead of the full second enclosure (Enclosure 2) being separated from first second enclosure (Enclosure 1), as depicted in FIG. 18, a partial separation of second enclosure might be implemented. For example, the second enclosure may be a mechanical sled that houses a smart phone (e.g., Apple iPhone). When separating the apparatus in order to give at least a mechanical enclosure housing a fingerprint scanner to a subject that is at a safe distance to the operator, the operator may remove the smart phone from the apparatus and place the rest of the apparatus in front of the subject, while still being able to communicate wirelessly with the fingerprint scanner containing apparatus that is in front of the subject.

In FIG. 10, a method of fingerprinting a subject is presented. In many applications involving fingerprinting prints from one or more fingers are required from both hands of a subject. For example, for access control to a building or to a computer, typically the index and middle finger from both hands might be used. Although each of these four fingers might be enrolled initially separately, this process takes more time and is prone to errors (subject either purposely or by accident placing the incorrect finger onto the platen).

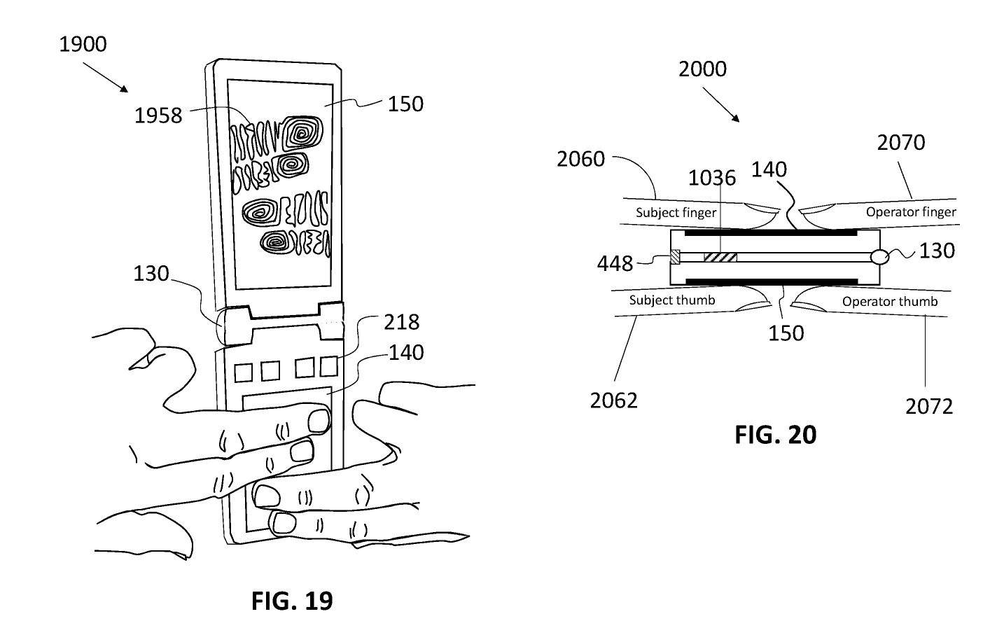

The method illustrated in FIG. 19 shows how for this example, all of four fingers can be enrolled simultaneously. The method illustrated in FIG. 19 can be extended to other scenarios where more or less fingers must be enrolled into a system and the presented method allows for all fingers to be enrolled simultaneously for these different count finger scenarios. The presented method is applicable for any fingerprint scanner apparatus that has sufficient scanning area to allow the required number of fingers to be scanned simultaneously and is not restricted to the housing design taught in this patent disclosure.

As shown on the display 150, fingerprint images 1958 are relayed from the fingerprint scanner 140 and displayed onto the display 150. Buttons 218 are available for controlling operation of the apparatus 1900.

In FIG. 20 a method of fingerprinting a subject is presented where simultaneously one or more fingerprints of an operator is acquired. Although FIG. 20 depicts both subject and operator grabbing the fingerprinting apparatus 2000 so that their respective thumbs 2062, 2072 are at the bottom of the device, the presented method applies to all fingerprint scanners and applies to handheld fingerprinting apparatus as depicted in FIG. 20 and to fingerprint scanners that are mounted to a surface wherein typically only the fingers 2060, 2070 respectively, and not the thumbs 2062, 2072 of the subject and operator would be in contact with the apparatus 2000. The method of simultaneously capturing fingerprints can be extended to two separate fingerprint scanners that may be contained in the same housing or in different housings. The described method is beneficial for high-security access control so that both the subject requesting access and the operator assisting in granting access can be identified and recorded.

As shown, the subject's finger 2060 and the subject's thumb 2062 grab the left side of the fingerprinting apparatus 2000, while the operator's finger 2070 and the operator's thumb 2072 grab the right side of the fingerprinting apparatus 2000.

The concept is similar to the access control of bank safety deposit boxes where both a personal key and a bank key may be required to access a safety deposit box, but in the fingerprinting method described, the system has the added benefit of identifying the people involved in the access control rather than identifying a key or keys that might be in possession of more than one person. The method is also useful when a subject is being fingerprinted for background checks, criminal booking, traffic or pedestrian stops by police, etc., since it is a method of confirming and recording the identity of the operator (such as a police officer) that was fingerprinting a particular subject.

The method may be extended to near simultaneous fingerprint scanning where the subject and operator do not simultaneously have their fingerprints scanned, but they are scanned within a certain short time period such as say 15 seconds or 30 seconds. The method may be useful for the case where the fingerprint platen may not be large enough to simultaneously fit both the subject's and the operator's required fingers. In all of the configurations presented, it may be advantageous to secure the apparatus to a surface where the surface may be approximately horizontal or not.

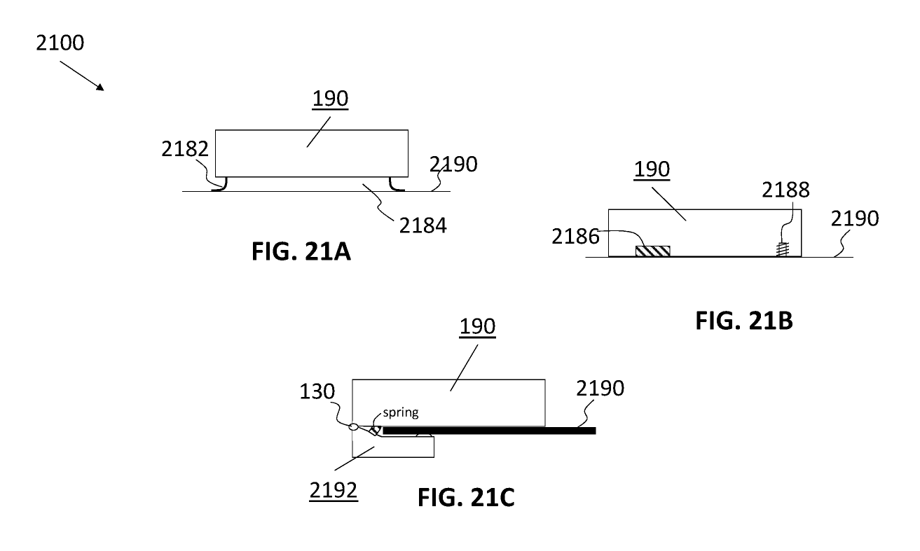

As illustrated in FIG. 21A-21C there are several options for securing a housing 190 to a surface 2190. As illustrated in FIG. 21A, a flexible membrane, gasket, or other material 2182 may be part of one surface of the apparatus housing 190 and when pressed onto a surface 2190 ale flexible membrane 2182 will allow air to be pushed out and when the pressure on the apparatus is released, a vacuum 2184 is created. To separate the apparatus from the housing a means of adding air into this vacuum space 2184 is provided, such as a tab at one portion of the membrane 2182 that an operator can pull up to leak air through.

Alternatively or in addition, the apparatus may contain one or more magnets (either electro or static) 2186 or one or more tapped holes 2188 to secure the apparatus 190 to a surface 2190 that might be magnetic or has means for putting screws or other fixture tabs through as depicted in FIG. 21B. Alternatively or in addition to the apparatus may contain means by which the apparatus can be clipped 2192 to the edge of a surface as illustrated in FIG. 21C.

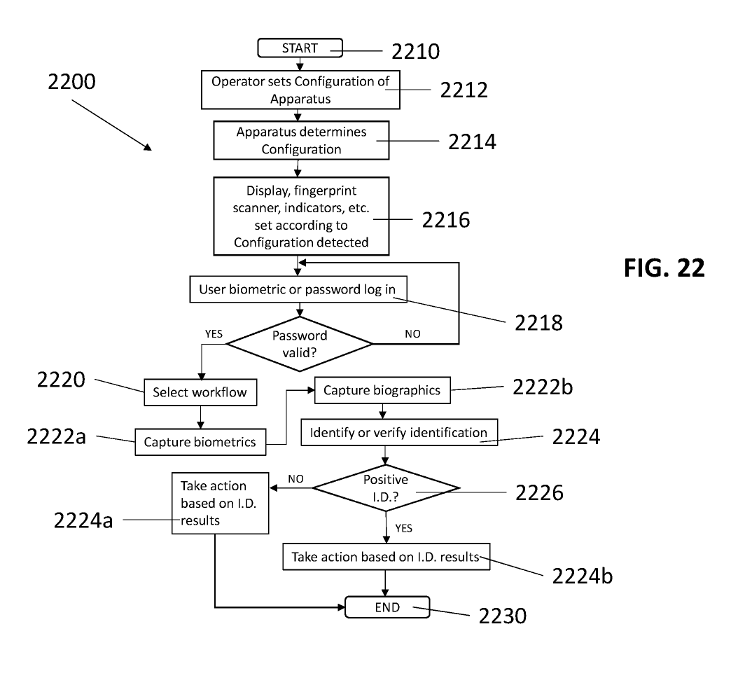

In FIG. 22, a flow chart 2200 describing one method of operating the apparatus of the present invention is depicted. At the start 2210 of the procedure, the operator places the apparatus in a given configuration 2212 and the apparatus senses (determines) the configuration 2214 and sets the display, fingerprint scanner, and indicators according to the sensed (detected) configuration 2216. Note that in addition to sensing the configuration. the apparatus may also be sensing position and orientation of the apparatus and display the orientation of the text and graphics on the display screen accordingly.

The operator may then be required to enter a biometric (e.g., fingerprint, face, iris, voice, etc.) to unlock (log in to) the apparatus, or alternatively or in addition to may be required to key in a password or gesture to unlock (log in to) the apparatus. If the log in procedure is successful (password is valid), the operator then chooses the workflow desired 2220, such as an identification or verification procedure. Then the operator will acquire (capture) the biometrics and biographics 2222a-222b that the particular workflow requires and the apparatus will check the inputted data to a database that might be resident with the apparatus or accessed remotely such as via a wireless communication means, to identify or verify identification 2224. The apparatus will give the operator feedback (Determine Positive I.D. ?) 2226 regarding the results of the information check and the operator will take the appropriate action 2224a-2224b, depending upon those results 2230.

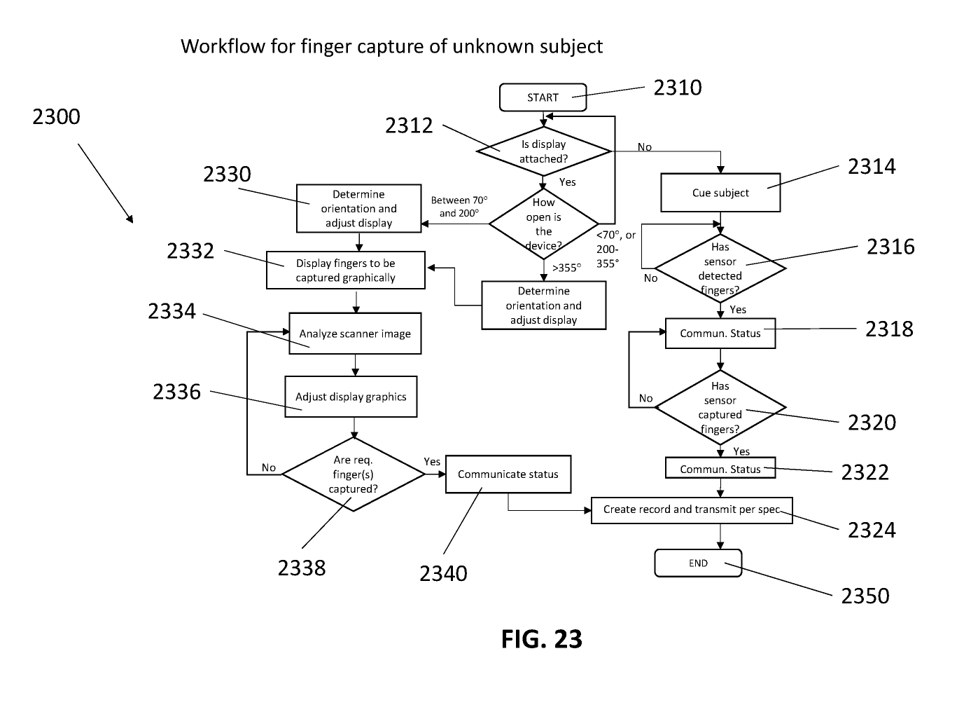

In FIG. 23, a flow chart 2300 for the operation of the apparatus of the present invention is depicted that describes one method of capturing the fingerprints of an unknown subject. Once this work flow is selected, at the start of the process, the apparatus begins checking the configuration that it is in (something it actually is constantly doing. Is the display attached? 2312 If the display enclosure is not attached to the fingerprint scanner enclosure, then the apparatus sets itself into Configuration 7 (See FIG. 18). The fingerprint scanner apparatus will cue the subject regarding what finger(s) is to be placed on the platen 2314. The cueing may be in the form of either or both of audio and visual indicators through an incorporated speaker, indicator lights, pictograms, or even a small display that is part of the scanner first enclosure (Enclosure 1). The system will wait until it has detected fingers 2316, and if so communicate status 2318 via audio or visual feedback and help guide the subject if certain finger(s) needs to be moved, have more pressure applied, etc.

Once the required finger(s) are captured 2320, the system again communicates the status 2322, and creates a record 2324, where the record may include a combination of actual fingerprint images, segmented images, fingerprint templates in additional to biographic information, input in a process step not shown in flowchart. The apparatus will then transmit this record per a given communication protocol to a processor for analysis where the processor may reside in the first or second enclosure of the apparatus or may be a separate processor outside of the apparatus housing.

If the display is attached, the system will determine if the housing 190 is opened between 70° and 200° corresponding to either Configuration 6 or 2 2330. Similarly it will determine if the housing 190 is opened up past 355° to indicate a Configuration 3.

As described earlier, it is preferred for Configuration 3 that the housing 190 can be locked in placed and that a sensor can determine the device is in the configuration. Since the exact angle of rotation corresponding to the apparatus locking into Configuration 3 depends upon the apparatus housing design, for purpose of specificity in FIG. 23, it will be assumed that an angle of 355° to 365° will correspond to a setting of the device into Configuration 3

If the device is not found to be in one of these configurations (for now the flowchart does not consider the case of the device being in Configuration 4 and 5) then the system keeps on checking the status of the configuration. Though not indicated in a process step, after determining that the device is not in a given configuration, it may give an audible or visual cue to the operator to indicate that the system has not been opened enough or possibly too much to be set to a certain configuration. Once the apparatus configuration is determined; the system will adjust the orientation of the display based upon feedback of any orientation sensing means (previously described) or operator inputs (touch or air gestures as well as button inputs).

The system displays graphically the fingers that are required to be captured on the display 2332. For example if the 4-fingers of the left hand are to be captured, then a graphic of 4 fingers from the left hand might be displayed. Preferentially this graphic of 4 fingers uses color, shading, or any other visual distinction in order to communicate which fingers placed on the platen may have an acceptable fingerprint quality in the scanned image and which do not.

Through the display or through other visual indicators or through audio cues, the subject can be coached regarding placement or pressure corrections that he should make in order to acquire sufficiently good quality fingerprint images. As the subject's finger(s) are moved and the quality improves or decreases, the apparatus updates or adjusts the display graphics 2336 or other feedback mechanisms being utilized. Once all required fingers are captured with sufficient quality 2338, the apparatus can create and communicate (transmit) a record for analysis 2334 as earlier described, and this procedure terminates 2350.

Illustrated in FIGS. 24A-24C are several embodiments of the apparatus while in a closed Configuration 1. To illustrate the interaction between the display and the fingerprint scanner, the gap of the cavity, measuring the distance that the display face is from the fingerprint scanner platen, is shown as being exaggerated. In general one wants to have as small a gap as possible.

In FIG. 24A we illustrate with a series of vertical downward arrows the imagery information that is projected 2462 by the display 150 down onto the fingerprint scanner 140 of apparatus 2400. This imagery information may be in the form of optical rays or electrical field lines. As described previously, in some embodiments, the imagery information 2402 is uniform across the face of the display in order to check uniformity of response of the fingerprint scanner 140 or may be a series of grayscale or binary features in order to test spatial resolution (e.g., projection of imagery representing a common AF 1951 resolution target).

Since no optical or electrical lens is drawn in the cavity area of FIG. 24A in order to map the projected imagery 2462 of the display direction only the fingerprint scanner 140, in general the information will diffract or otherwise blur with distance and hence there is motivation to minimize the gap 2464 of the cavity 2460 as much as possible. To help overcome any issues with the gap size, the apparatus may contain or the operator may place in the cavity 2460 a guiding material 2466 when conducting a scanner check or calibration procedure, see FIG. 24B, in some embodiments, the guiding material 2466 for the case of optical imagery is fiber optic bundle such as those sold by Incom (Charlton, Mass.).

Another example of the guiding material 2466 is a microlens array (such as those RPC Photonics of Rochester, N.Y. can manufacture) that is designed to optically relaying the display surface onto or close to the plane of the fingerprint platen. For the case of electrical imagery, an electrically anisotropic material (i.e., conductivity primarily in one direction) may be contained in the guiding material such as anisotropic material made by Hitachi Chemicals and Sony Chemicals & Information Devices.

For the case of a fingerprint scanner that is optical (optically sensitive) and operates under the condition of TIR (Total Internal Reflection), light coming from an air gap cannot without some source of scattering propagate in the fingerprint scanner at the required TIR angle to be properly detected. There may be internal features of the fingerprint scanner 140 that create enough scattered light that some of the light from the display 150 can enter the fingerprint scanner 140, become scattered at a TIR angle and be read by the fingerprint scanner detector 1001411 An alternative if the scattering internal to the fingerprint scanner 140 is not sufficient is to optically couple a diffuser to the fingerprint scanner 140 as illustrated in FIG. 24C. The diffuser 2470 can be a surface-relief diffuser (e.g., a rough uniform surface), a holographic diffuser such as those made by Luminit of Torrance, Calif., or a volume diffuser such as opal glass. The optical coupling may be achieved with a liquid such as water or a solvent such as isopropyl alcohol (IPA), but may also be achieved through the use of silicones, urethanes or similar materials. Cured silicones such as those described in U.S. Pat. No. 7,319,565 are self-wetting to most surfaces (particularly fingerprint platens) and there is no cleaning issues when the silicone is removed. If the display 140 can be brought close enough to the diffuser, the system may be able to check resolution of the fingerprint scanner 140 by having the display 150 project a suitable optical target pattern.

However, to bring the target 2472 as close to the fingerprint scanner platen as possible, it may be required to introduce a target 2472 (such as a transparency composed of clear 2468 as well as partially opaque or opaque 2476 areas describing resolution features such as those of the AF 1951 target or otherwise). This target 2472 may have a diffuser surface on the side facing the display 150 or it may be optically contact to a diffuser 2470 (layer of coupling material 2474 for optically contacting diffuser 2470 to the target 2472 is not drawn between the target 2472 and the diffuser 2470.

The apparatus of the current invention, by way of example, in some embodiments, when in the closed position is in a form factor conducive to being carried by or inside of a shirt or pants pocket. For example, the current invention may utilize a 800×480 pixel LCD display screen currently in mass production that has a 7″ diagonal and an active area of 154×89 mm. This display size is large enough to cover a FAP 60 fingerprint scanner that meets the FBI-required 3.0″×3.2″[76.2×81.3 mm] active scanning area that allows non-rotated 4 fingers to be simultaneously scanned.

In some embodiments, the display includes touchscreen capabilities to enable navigation as well as a display touch keyboard for data entry or software menu selections. In this embodiment, the device could additionally include a commercially available autofocus face camera for capturing color mugshot, crime scene photos or just general video of a suspect or scene.

Optionally, included is a separate monochrome autofocus camera for capturing iris biometric images at distances of ˜12″ such as those iris cameras available from FotoNation (San Jose, Calif.). Both the face camera and the iris camera have package volumes that are roughly 6 mm cubes or smaller.

The FAP 60 fingerprint scanner can be made using TFT (thin-film transistor) technology and as such the size of the fingerprint scanner with electronics would be approximately 3.5″×3.5″ by 12 mm thick [89×89×12 mm.]Including batteries, wireless communication, and an ARM processor and memory for enabling capturing and processing of biometrics, the entire apparatus in the closed position is roughly 160 mm×100 mm×20 mm thick (6.3″×4.0″×0.8″) and weigh less than 1.5 lbs.

To shrink the package volume down further while still maintaining the ability to capture 4 fingers simultaneously on the finger platen, the finger platen is changed to an active scanning area of 2.5″×3.2″ [63.5×81.3 mm] such as the area found for rotated 4-finger slaps in a Type 14 fingerprint record. Optionally, a custom display is used to match the fingerprint platen size. Also a commercially available, mass-produced 5″ diagonal 800×480 pixel color LCD display is available. Such 5″ diagonal displays have an active area of approximately 108×65 min which will cover the 2.5″×3.2″ four-finger capture platen.

In this circumstance, the device could be packaged with the batter, face camera, iris camera, and wireless communication features previously cited into a volume of less than 120 mm×80 mm×20 mm thick [4.7″×3.1″×0.81″] and weigh less than 1.0 lb. As a point of reference, an iPhone 6 Plus from Apple (Cupertino, Calif.) is 158×80×7 mm in package size and weighs 0.38

lbs.

In other embodiments of the current invention, the display used is custom designed and manufactured in order to further shrink the package size of the device, and/or the fingerprint scanner area is reduced. For example, optionally a FAP 45 scanner capable of capturing two fingers simultaneous is used. Such scanners are specified by the FBI to have an active area of at least 1.5″×1.6″ [38.1×40.6 mm].

In this case, a display smaller than a 5″ diagonal previously cited can be used, for example, such as commercially available 3.5″ diagonal displays. Such displays have active areas of 70×53 mm and the apparatus with the exemplary features cited earlier can be packaged in a volume of less than 100×63×20 mm [4.0″×2.5″×0.8″], which easily fits into a pants and even shirt pocket.

In summary, in some embodiments, the invention provides an apparatus for biometric measurement, including a fingerprint scanner, an electronic display, a housing that is configured to be placed into at least one open state and a closed state, and when the housing is placed into a closed state, the fingerprint scanner and said electronic display are disposed facing each other and forming a cavity between said fingerprint scanner and said electronic display, and when the housing is placed into an open state, said fingerprint scanner can be placed into operation to capture a representation of a fingerprint pattern from a finger of a particular person, and wherein said electronic display is configured to display information in association with said operation of said fingerprint scanner.

Optionally, the fingerprint scanner is a fingerprint scanner that is optically sensitive, and when the housing is in the closed state, the electronic display projects an optical image pattern that is received by said fingerprint scanner. The image pattern is employed by said optical fingerprint scanner for performing measurement of said operation of said optical fingerprint scanner. The measurement of the operation of the optical fingerprint scanner is employed for performing calibration of said optical fingerprint scanner.

Optionally, the fingerprint scanner is an electrically sensitive, and when the housing is in a closed state, the electronic display generates electrical signals that are received by the fingerprint scanner. The electrical signals are employed for performing measurement of said operation of said electrically sensitive fingerprint scanner. The measurement of the operation of said electrically sensitive fingerprint scanner is employed for performing calibration of the electrically sensitive fingerprint scanner.

Optionally, when the housing is in the closed state, the cavity within the housing is illuminated with ultraviolet light for performance of disinfection of the optical finger print scanner and of said electronic display.

In some embodiments, the housing includes a first enclosure and a second enclosure, that are connected together via a hinge, and the fingerprint scanner is disposed within the first enclosure and the electronic display is disposed within said second enclosure. Optionally, the fingerprint scanner and said electronic display are configured to be facing in opposite directions, and where an image representing a linger print scan is displayed via said electronic display.

The invention also provides for method for fingerprint measurement, including the steps of providing a fingerprint scanner that is configured to scan a fingerprint from each of at least two fingers at one time, scanning a fingerprint from at least one finger from each of both hands of a subject, storing a representation of each the fingerprint for the at least one finger from each of both hands as a record for future reference.

Optionally, the at least one finger from each of both hands is the same linger from each of both hands. Optionally, the at least one finger from each of both hands is the index finger.

In some embodiments, the fingerprint scanner is configured to scan a fingerprint from at least four fingers at one time. Optionally, the same two fingers from each of both hands are scanned at one time. Optionally, the same two fingers are the middle and index fingers.

The invention also provides for method for fingerprint measurement, including the steps of, providing one or more fingerprint scanners: performing a first scanning a fingerprint for at least one finger of a subject, and performing a second scanning a fingerprint for at least one finger of an operator, on a same or different one of said fingerprint scanners, and storing a representation of each fingerprint for the subject (person) and for the operator (person) in association with each other to create a record indicating that operator was present when performing a first scanning a fingerprint for at least one finger of a subject.

Optionally, the first and said second scanning occurs simultaneously. Or the first scanning and said second scanning occur within a period of about 5 minutes. Optionally, the representation of each said fingerprint is segmented and the representations are associated with each other in storage.

In summary, the present invention comprises one or embodiments of an apparatus, a system and a method that incorporates and utilizes at least a fingerprint image capturing scanner and a visual display. The electronic display is configured to display information in association with operation of the fingerprint scanner The fingerprint scanner may incorporate any known technology for scanning fingerprints, but preferably includes technology enabling the fingerprint scanner to be thin, compact, lightweight and low-power consumption, all valuable properties of a component that is to be incorporated into a mobile hand-held device.

The display may incorporate any known technology such as LCD and OLED and preferably incorporates touch sensing technologies known in the art such as resistive, capacitive, or infrared grids or may incorporate air gesture sensing technologies for interaction with the display. The technologies incorporated into the display preferably enable the display to be thin, compact, lightweight and low-power consumption, all valuable properties of a component that is to be incorporated into a mobile hand-held device.

Embodiments of the apparatus include a mechanical housing, that comprises a mechanical hinge that joins two distinct mechanical enclosures of the apparatus where the first mechanical enclosure contains at least a fingerprint scanner and the second mechanical enclosure contains at least a visual display. The mechanical hinge, also referred to herein as a hinge mechanism, of the present invention is preferentially designed to provide for several advantageous mechanical configurations.

The hinge mechanism of the apparatus may be any hinge known in the prior art. For example, the hinge mechanism may comprise one or multiple distinct hinges or may be a continuous hinge such as a flex cable or fabric. The binge may be a friction hinge or a hinge with detents in order to define fixed positions that the apparatus can be “clicked” into, The hinges may also have a locking mechanism in order to fix the two parts of the apparatus relatively to each other. The hinge may be spring-loaded and/or mechanically dampened to limit the rate of change when moving the two mechanical enclosures relative to each other.

Embodiments of the apparatus preferentially include a mechanism by which the position of the first and second mechanical enclosures is determined. The hinge mechanism itself may have a mechanical or electronic means for determining the position or the mechanism may be contained in either or both of the first or second mechanical enclosures. Additionally the apparatus may include a mechanism (e.g., gyros and single-axis or multi-axis accelerometers) by which orientation of the apparatus relative to the direction of the pull of gravity is determined or mechanism by which accelerations of the apparatus in different axes such as Cartesian may be determined. Depending upon the readings of the position, orientation, and/or acceleration means, the apparatus may be programmed to enter into a certain operational modes.

In addition to incorporating a fingerprint scanner and a display, the apparatus of the present invention preferably contains one or more processors (for controlling electronic functions of included components), memory chips (for storing program control code, register settings, graphics for the display and images/templates from the fingerprint scanner), and a power supply (enabling the apparatus to operate in a mobile and untethered use-scenario).

The apparatus may include a mechanism by which the internal power supply can be recharged such as through the use of rechargeable batteries and use of detachable wire or through wireless induction. The apparatus may contain wires for communication and power that link the first and second mechanical enclosure via the hinge mechanism, thereby enabling both enclosures of the apparatus to have power and be able to communicate with each other.

Additionally or in lieu of, the apparatus may contain wireless communication electronics to enable wireless communication between the electronics of the first and second mechanical enclosures or, or in addition to wireless communication with another separate electronic device. The wireless communication may follow one or more of wireless protocols known in the art including cellular, Bluetooth and 802.11 protocols.

Alternately or in addition to the wireless communication, physical communication to an external electronic device may be achieved through physical wiring that byway of example, may follow the specifications of USB, Firewire, RS-232, or Thunderbolt, or any other wired communication protocol known to one skilled in the art. These physical connection wires may be used to supply power such as for recharging one or more internal batteries of the apparatus or the charging of the battery can be designed to be accomplished wirelessly, such as with inductive charging.

The apparatus of the present invention may also include one or more of visible indicators and speakers to provide visual and audible feedback. The apparatus may also include cameras capable of capturing biometric images of a face, irises, ears, or face thermal characteristics, as Welt as cameras designed to take pictures of the environment or specifically fingerprint patterns, shoe prints, or other crime scene evidence.

To aid the operation of the aforementioned cameras, the apparatus may include illumination sources that may contain one or more wavelengths in in one or more of the ultraviolet (UV), visible, or infrared (IR) spectral bands. These illumination sources may contain means by which structured light is emitted to enable the cameras to extract 3D information from a scene. Alternatively stereo cameras of any other 3D camera/illumination technology known in the art may be incorporated in to the apparatus of the present invention. The camera may be mounted on the outside of the apparatus so that when it is carried by the operator, it may provide a real-time record of events that transpire. For example, the apparatus and its camera may be used by a police officer to record the events of a traffic stop while the apparatus is clipped to the vest pocket of the police officer.

Additional the present invention may include a microphone and associated electronics to record acoustic signals and optionally to detect specific acoustic signals, such as required in voice recognition, speaker recognition, and gunshot detection. The microphone may consist of a directional array and associated electronics known in the prior art (see for example U.S. Pat. No. 7,688,679) capable of detecting gunshot acoustic signatures and determining the location of the weapon fire. GPS (Global Positioning System) location electronics may also be incorporated into the apparatus.

A first mechanical configuration of the apparatus of the present invention allows for first mechanical enclosure to be parallel and on top of the second mechanical enclosure such that the fingerprint scanner is facing the display. When the housing 190 is in this “closed” configuration both the fingerprint scanner and the display are mechanically protected. When placed into this configuration, the apparatus may initiate a shut-down (power-off), sleep, or a hibernation mode of the electronics, but may also, in the case of an optical fingerprint scanner, enter into a calibration mode.

By way Of example, when the system enters this calibration mode, the electronics of the apparatus may instruct the display to project information that the fingerprint scanner can detect. In the case of an optical fingerprint scanner, several different settings of uniform color and intensity may be projected which the fingerprint scanner is capable of reading. In the case of a fingerprint scanner that measures electrical properties, the display may project an electrical image such as through the use of an array of electrodes (preferably optically transparent electrodes such as those fabricated with ITO) that either are specifically deposited onto the display or are integrated or part of a touch screen capability the display has.

In order to couple the information project from the display to the fingerprint scanner a material or materials may be placed in between the display and the fingerprint scanner, such as, but not limited to, water, silicone, an optical diffuser, an anisotropic electrical material, etc. By reading the fingerprint scanner's collected image in response to the display's one or more projected images., fingerprint scanner information such as defective pixels, PRNU (Photo Response Non-Uniformity), and FPN (Fixed Pattern Noise) can be determined and optionally corrected. Similarly if the fingerprint scanner is determined to be calibrated, it can be the display uniformity and pixel defects that is determined through this process.

The display may also be set to project different series of patterns in order to test the spatial resolution of the scanner. After performing this checking or optional calibration procedure, the system may enter a shut-down (power-off), hibernation, or sleep mode. When the apparatus is in said first “closed” configuration, the apparatus may contain one or more of an electronic or mechanical locking mechanism to fix the apparatus in said first configuration,

An optical fingerprint scanner is also referred to herein as being an optically sensitive fingerprint scanner. In some embodiments, the electronic display is configured to project an optical image pattern that is received and captured by optically sensitive fingerprint scanner. In some embodiments, the image pattern that is projected from said electronic display is captured by the optically sensitive fingerprint scanner to perform measurement of the operation of the optically sensitive fingerprint scanner. Optionally, such measurement of the operation of the optically sensitive fingerprint scanner is employed for calibration of the optically sensitive fingerprint scanner.

A capacitive fingerprint scanner is also referred to herein as being an electrically sensitive fingerprint scanner. In some embodiments, the electronic display is configured to generate electrical signals that are received by the electrically sensitive fingerprint scanner, hi some embodiments, the signals are received to perform measurement of the operation of the electrically sensitive fingerprint scanner. Optionally, such measurement of the operation of the electrically sensitive fingerprint scanner is employed for calibration of the electrically sensitive fingerprint scanner.

A second apparatus configuration allows for the first mechanical enclosure to be parallel and located to the side of the second mechanical enclosure such that the fingerprint scanner and display are both facing the same direction. This is achieved via rotating the first mechanical enclosure roughly 180° relative to the second mechanical enclosure via the hinge mechanism of the apparatus. In the second configuration, a person may place their finger or fingers on the fingerprint scanner and the same or different person may observe the display. The field-of-view (FOV) of the display may be set statically or dynamically such that the person (subject) who is having his fingerprints acquired cannot see or has significantly reduced visibility of the display output, while the different person (operator) observing the display can see the visible imagery.

In this second configuration, preferentially the fingerprint scanner can be presented to the subject either straight in front of them, or to the left or to the right of the display. in certain use-cases the subject is allowed to view the display, and in the applications, the display preferentially gives feedback to the subject regarding which fingers to place on the scanner and feedback regarding positional corrections. Graphical techniques for providing the finger positioning requests for fingerprint scanners may be found in the teachings of Wolfer and Baumeister in U.S. Pat. Appl. 2014/0079300 and the teachings are incorporated herein.

Feedback to the subject and the operator regarding the status of the fingerprint acquisition or processing step being executed may also be given via visible indicators (for example LED status lights of different colors and positions) as well as via audible signals (e.g., beeps, melodies, or audible words) via an incorporated speaker. Since the fingerprint scanner and hence the display may be rotated various directions relative to the subject, the current invention preferably has a means by which the display can be rotated to the proper orientation. This means includes use of buttons on the apparatus, use of finger gestures (touch or air) read by the display, or the use of gyros that determine the orientation of the display and rotate the display appropriately.

In another embodiment of the present apparatus, the hinge mechanism allows the first mechanical enclosure to rotate approximately 360° relative to the second mechanical enclosure. In a third configuration, this 360° rotation allows the fingerprint scanner and display to be on top of each other, but facing opposite directions with the fingerprint scanner and display situated on the outside of their respective enclosures.

In this configuration fingerprints can be taken of a subject by having the subject preferentially squeezing the apparatus while having the required fingers on the fingerprint scanner. In this manner, there is little downward force that the operator who may be bolding the opposite end of the apparatus would need to counteract. For the case where the display is facing towards the subject and the fingerprint scanner is underneath the folded apparatus of Configuration 3, the display may relay the outline, filled in outline, or actual fingerprints that is being read by the fingerprint scanner to provide the subject feedback regarding finger placement.

Alternatively, the apparatus while in this third configuration may be placed on top of a subject's hand such that the fingerprint scanner is resting on the finger(s) of interest. As mentioned earlier, the outline, filled in outline, or actual fingerprints that is being read by the fingerprint scanner can be relayed to the display screen of the apparatus in order to aid in alignment of the fingers. Feedback messages may also be relayed On the display that by way of example describe which finger(s) are to be scanned and whether or not they should be moved once on the fingerprint scanner in a certain manner to get a better fingerprint collection.

In a fourth configuration, the hinge mechanism allows for the rotation of the two mechanical enclosures in more than one plane, thereby allowing the first and second enclosure to be one on top of each other as in Configuration 3, but now with the fingerprint scanner facing outward and the display facing inward and hidden. In this configuration the fingerprint scanner may still be used, but preferentially there are at least indicators which by way of example may be audible cues, lit buttons, or LED indicators that give feedback regarding the state the apparatus is in and what the computing system of the apparatus expects in terms of placement of finger(s) on the fingerprint scanner.

In a fifth configuration, the hinge mechanism of the fourth configuration is positioned such that the two mechanical enclosures he on top of each other, but now it is the display that faces the outside of the apparatus and the fingerprint scanner is facing inward, effectively hiding and protecting the fingerprint scanner. In this fifth configuration, the operator has control of the device through the display screen, which preferentially has touch input capabilities as well as buttons and microphones that are integrated into the apparatus.

In a sixth configuration, the mechanical hinge allows for the first and second mechanical enclosure to be at approximately 90 degrees relative to each other such that a person can place their one or more fingers onto the fingerprint scanner in response to guidance given by the display.

In a seventh configuration the mechanical hinge may allow the first mechanical enclosure containing at least a fingerprint scanner to physically separate from the second mechanical enclosure containing at least a display. In this configuration, the subject may be presented the first mechanical enclosure and be at a distance the operator controlling the second mechanical enclosure considers safe in case the subject considers inflicting harm on the operator. 1001891 In this seventh configuration, the first and second mechanical enclosures contain their own power source and some form of wireless communication so that the first and second mechanical enclosures can communicate with each other. The operator may use visual indicators or sound outputs from either one of the first or second mechanical enclosures or use vibration feedback (for example how cell phones in silent mode communicate that a text or a telephone call is being received) in order to get feedback regarding the status of the processing steps of the apparatus.

This invention also covers some novel electronic fingerprinting methods. In one method, a subject that is to be fingerprinted for an access control application (for example to - his identity at a bank or to gain access at a door to a business), the subject when initially enrolled places all of his fingers to be enrolled simultaneously on the platen of a fingerprint scanner. For example, if the bank policy is to enroll the index and middle finger of each employee, then that employee, when enrolling in the system will place his index and middle finger for both hands on the platen simultaneously and the system's software will take the image and by analyzing the direction of the fingerprint blob (regions of high spatial frequency in the image) and the relative positions of the blobs will make the determination of which blob corresponds to which finger for the purposes of segmentation and template generation.

The method can be applied regarding of the number of fingers required for enrollment and by simultaneously presenting all fingers, the enrollment process is faster, less prone to error in the proper finger(s) being enrolled and less prone to fraud where a person will try to enroll his fingers upside down or to enroll a non-distal portion of a finger phalanx. This method is applicable regardless of the number of fingers to be enrolled into a system and is applicable for any fingerprint scanner and not limited to the handheld embodiments described herein.

In a second method, the subject and the operator both place their fingers onto the fingerprint scanner at the same time thereby providing a confirmed record that a particular operator was present when the subject was fingerprinted. If the subject is required to place a certain number of fingers onto the platen for identification, verification, or enrollment, the operator may be required to place the same or different number of fingers for confirming the operator's identity. Such a method may be used in high-level access control situations where it is important to record the identity of a guard at the same time as recording the identity of the subject seeking access.

The method may also be used in a police environment where it is beneficial to record automatically the identity of a subject that had their fingerprints taken, where the fingerprints are taken for any variety of applications such as criminal booking, background checks, or identification in a routine pedestrian or road stop. The method is application for any fingerprint scanner and not limited to the handheld embodiments described herein.

This brief description of the invention is intended only to provide a brief overview of subject matter disclosed herein according to one or more illustrative embodiments, and does not serve as a guide to interpreting the claims of to define or limit the scope of the invention, which is defined only by the appended claims. From the foregoing description, it will be apparent that there has been provided an improved arrangement for a hand-held electronic apparatus capable of capturing fingerprints as well as improved methods for capturing the fingerprints. Variations and modifications in the herein described reader, and method of use will undoubtedly suggest themselves to those skilled in the art. Accordingly, the foregoing description should be taken as illustrative and not in a limiting sense.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Parts List

100 Apparatus of FIG. 1

110 Enclosure 1

120 Enclosure 2

130 hinge

140 finger print scanner

150 display

190 housing

200 Apparatus of FIG. 2

216 global positioning system (GPS) electronics

218 button(s)

220 camera(s)

222 illumination module

230 processors and memory components

232 microphone(s)

234 speaker

240 inertia measurement unit

242 machine readable zone reader

244 indicator(s)

252 disinfection component

270 power/data connection

272 wireless antenna and associated electronics

274 power supply

276 hinge sensor

278 buttons

310 battery charging system

320 touch screen

330 memory

336 speaker/microphone

342 MRZ reader

344 magnetic stripe reader

350 disinfection component

374 power supply

376 battery

400 Configuration 1 of Apparatus of FIG. 4

430 hinge

436 hinge position sensor

448 locking mechanism

452 disinfecting means

500 Configuration 1 of Apparatus of FIG. 5

552 disinfection means

554 ultraviolet (UV) light

600 Configuration 2 of Apparatus of FIG. 5

618 buttons

630 hinge

700 Apparatus of FIGS. 7a-7b

718 buttons

730 hinge

754 displayed text

756 displayed graphic

800 Apparatus of FIGS. 8a-8b

818 buttons

854 displayed text

856 displayed graphic

900 Apparatus of FIGS. 9a-9c

920 camera

960 lenticular array

962 light emitting layer

972 Ray A

974 Ray B

976 Ray C

982 Pixel A

984 Pixel B

986 Pixel C

1000 Apparatus of FIG. 10

1036 pressure sensor

1100 Apparatus of FIG. 11

1118 touch screen buttons

1158 fingerprint scanner image

1200 Apparatus of FIG. 12

1218 touch screen buttons

1254 displayed overlay text

1256 displayed overlay graphics

1258 fingerprint scanner image

1300 Apparatus of FIGS. 13a-13b

1358 image from fingerprint scanner

1362 area of thumb making contact with display

1364 feedback area

1400 Apparatus of FIG. 14

1446 configuration sensor

1500 Apparatus of FIG. 15

1600 Apparatus of FIG. 16

1610 Enclosure 1

1620 Enclosure 2

1680 communication power cable

1682 spherical hinge socket

1684 hinge ball

1700 Apparatus of FIG. 17

1800 Apparatus of FIG. 18

1836 speaker/microphone

1900 Apparatus of FIG. 19

1958 fingerprint images relayed from fingerprint scanner

2000 Apparatus of FIG. 20

2100 Apparatus of FIGS. 21c-21c

2182 membrane

2184 vacuum

2186 magnet

2188 tapped holes

2190 surface

2192 clip

2400 Apparatus of FIGS. 24a-24c

2460 cavity

2462 projected imagery information, light rays

2464 gap

2466 guiding material

2468 clear area

2470 diffuser

2472 target

2474 coupling material

2476 opaque or partially opaque area

What is claimed is:

1. An apparatus for biometric measurement, comprising:
a fingerprint scanner having an active area with dimensions of at least 0.55 by 0.55 inches;
an electronic display;
a housing that is configured to be placed into a folded state or un-folded state, and said housing being further configured to be placed into an open state or a closed state when said housing, is placed into a folded state, and wherein
when placed into a folded state, said housing occupies a volume of space of limited dimension to enable carrying of said housing by a clothing pocket; and
when said housing is placed into an open state, said fingerprint scanner can be placed into operation to capture a representation of a fingerprint pattern from at least one finger of a particular person, and wherein said electronic display is configured to display information in association with said operation of said fingerprint scanner.

2. The apparatus of claim 1, when said housing is in said closed state, said fingerprint scanner is a fingerprint seamier that is optically sensitive, and wherein said electronic display projects an optical image pattern that is received by said fingerprint scanner.

3. The apparatus of claim 1, when said housing is in said closed state, said fingerprint scanner is an electrically sensitive fingerprint scanner and wherein said electronic display generates electrical signals that are received by said fingerprint scanner.

4. The apparatus of claim 1 wherein when said housing is in the closed state, said cavity is illuminated with ultraviolet light for performance of disinfection of said optical finger prim scanner and of said electronic display.

5. The apparatus of claim 1 wherein when in an open state, said fingerprint scanner and said electronic display are configured to be facing in opposite directions, and where an image representing a finger print scan is displayed via said electronic display.

6. The apparatus of claim 1 wherein said fingerprint scanner satisfies image quality standards of the federal bureau of investigation (FBI) electronic fingerprint transmission specification.

7. The apparatus of claim 1 wherein said fingerprint scanner has active area dimensions of at least 0.55 inches by 0.72 inches.

8. The apparatus of claim I wherein said fingerprint scanner has active area dimensions of at least 2.7 inches by 2.88 inches.

9. The apparatus of claim 1 wherein said housing occupies a volume of space of 160 mm by 100 mm by 26 mm, or less.

10. The apparatus of claim 1 wherein said display communicates information to said fingerprint scanner when said housing is in a closed state.

11. The apparatus of claim 1 wherein said fingerprint scanner is configured to scan an image of a document that is stored into memory.

12. A method for fingerprint measurement, comprising:
providing a fingerprint seamier that is configured to scan a fingerprint from each of at least two fingers at one time;
scanning a fingerprint from at least one finger from each of both bands of a subject;
storing a representation of each said fingerprint for said at least one finger from each of both hands as a record for future reference.

13. The method of claim 12 wherein said at least one finger from each of both hands is the same finger from each of both hands.

14. The method of claim 12 wherein said at least one finger from each of both hands is the index finger.

15. The method of claim 12 wherein said fingerprint scanner is configured to scan a fingerprint from at least four fingers at one time.

16. The method of claim 12 wherein the same two fingers from each of both hands are scanned at one time.

17. The method of claim 12 wherein the same two fingers are the middle and index fingers.

18. A method for fingerprint measurement, comprising the steps of:
providing one or more fingerprint scanners;
performing a first scanning a fingerprint for at least one finger of a subject, and
performing a second scanning a fingerprint for at least one finger of an operator, on a same or different one of said fingerprint scanners;
storing a representation of each said fingerprint for said subject and for said operator in association with each other to create a record indicating that said operator was present when said performing a first scanning a fingerprint for at least one finger of a subject.

19. The method of claim 18 wherein said first and said second scanning occurs simultaneously.

20. The method of claim 18 wherein said representation of each said fingerprint is segmented.
